(19) United States
(12) Patent Application Publication
(10) Pub. No.: US 2026/0187830 A1
(43) Pub. Date: Jul. 2, 2026

(54) INSPECTION CAMERA DEPLOYMENT SOLUTION

(71) Applicant: EIGEN INNOVATIONS INC., Fredericton (CA)

(72) Inventors: Edward PARROTT, Fredericton (CA); Joshua K. PICKARD, Fredericton (CA); Rickey DUBAY, Fredericton (CA)

(21) Appl. No.: 19/114,150

(22) PCT Filed: Sep. 25, 2023
(86) PCT No.: PCT/CA2023/051266

§ 371 Date: Mar. 21, 2025

Related U.S. Application Data
(60) Provisional application No. 63/409,626, filed on Sep. 23, 2022.

(51) Int. Cl. G06T 7/70; G01N 21/95; G06F 3/04815; G06F 3/0482; G06T 17/20

(52) U.S. Cl. CPC G06T 7/70; G01N 21/9515; G06F 3/04815; G06F 3/0482; G06T 17/20; G06T 2207/30244

(57) ABSTRACT

System and method that includes: synthesizing continuous sets of valid camera deployment solutions for the inspection of any selected facets of any arbitrary part mesh while certifying the satisfaction of all associated imaging and task constraints.

### RELATED APPLICATIONS

This application claims the benefit of and priority to U.S. Provisional Patent Application No. 63/409,626 filed Sep. 23, 2022.

### FIELD

This disclosure relates generally to imaging systems applied to industrial inspections, and more particularly to systems and methods for analyzing and synthesizing camera deployment solutions for the inspection of arbitrary 3D geometries in industrial facilities, including camera sensor and lens selection, camera pose(s), and associated system inspection performance.

### BACKGROUND

As manufacturing factories become increasingly automated, the frequency of machine vision inspection solution deployments is rapidly increasing. Machine vision inspection solution deployments can include one or more thermal imaging systems (e.g., near-infrared (NIR) and infrared (IR) systems), optical imaging systems (e.g., Red-Green-Blue (RGB), and Hue-Intensity-Saturation (HIS), and monochrome imaging systems), hyperspectral imaging systems (HSI), and other electromagnetic (EM) wave detection based imaging systems. Manufacturers continue to lean on automation to improve production efficiencies and reduce costs. Combined with the advent and adoption of machine learning and deep learning, highly capable machine vision inspection solutions are yielding an enormous increase in the number of cameras present in manufacturing plants that solve an ever-expanding range of inspection tasks more rapidly, efficiently, and reliably than previously possible.

The increasing demand and efficacy of machine vision, the ever-increasing complexity of modern manufacturing processes, and the growing machine vision hardware options, presents significant integration challenges to address machine vision deployment issues such as: (i) What combination of hardware is necessary for the application?; (ii) How and where does the hardware need to be installed and configured?; and (iii) Will the resulting machine vision inspection achieve the requirements of the inspection task?

Inspection tasks, along with a wide range of other industrial machine vision tasks, are heavily reliant on the ability of image sensors (e.g., cameras) to capture consistent, reliable, high-quality images of the manufactured part. Achieving appropriate inspection conditions requires careful attention to the types, quantities, and placements of cameras in the manufacturing environment (also referred to herein as a workspace). This problem is referred to as the sensor or camera deployment problem.

For a given inspection task, a camera deployment solution can include, among other things, the following parameters: (i) The number of cameras required; (ii) The camera type(s) (make and model) and lens type(s) (make and model); (iii) The relative pose (position and orientation) of the camera(s) to a part or region-of-interest.

The implementation of machine vision quality inspection on manufacturing lines is a well-established practice with a long history. The camera deployment is normally left to an experienced hardware integrator or solution engineer who manually selects what they believe is the best deployment for the task based on their experience, intuition, and with the aid of dimensional drawings and digital models. While good deployment results are possible for simple tasks, this approach becomes increasingly complex, time consuming, and error-prone, especially with: (i) Large and complex (non-flat) part geometries; (ii) Inspection tasks that require multiple cameras to achieve full inspection coverage; (iii) Occlusions caused by external objects (e.g., a manufacturing line); (iv) Imaging constraints (eg. resolution, angle of incidence, distance, etc.); (v) Challenging deployment considerations (eg. camera mounting constraints); and (vi) Multiple part geometries.

Selecting the wrong hardware for an inspection task can be a major problem. Integrators may deploy undesirable hardware in to order to maintain scheduling requirements and prevent further downtimes and costs for additions hardware integrations. Inexperience also results in undesirable hardware selections and deployments, where the integrator or engineer simply did not have a thorough enough understanding of the hardware or task to properly account for the imaging and task constraints. These scenarios lead to undesirable camera deployments that must operate outside of their hardware specifications, are unable to achieve the various the requirements of the inspection task, and result in significant risk to the success of the inspection solution. A significant number of unused vision systems exist in factories around the world because the hardware was not correctly selected for the desired application.

The camera deployment problem can be subdivided into two categories: Analysis—given the specific sensor and lens hardware and associated pose(s), what is the system's performance on a given inspection task ?; Synthesis-given the inspection task, what sensor and lens hardware and pose(s) satisfy the task?. Effectively, the analysis problem is a sub-problem of synthesis problem and thus synthesis methodologies also encompass analysis methodologies.

The use of automated tools such as solvers for synthesizing camera deployment solutions is a relatively new area of study. Identifying valid sensor deployments for the reliable inspection of the surface of a part with a known geometry is classically a very difficult problem. These deployments generally rely on the application of heuristic-based approaches and stochastic optimization tools to find distinct valid sensor deployment solutions to a considered set of constraints. These distinct solutions can provide a candidate sensor deployment that satisfies the inspection requirements for the part; however, real-world complexities such as installation uncertainties, internal/external occluding geometries, and part dimensional instability and other typical geometric variations, limit the vast majority of sensor deployment algorithms to academic exercises, as the certification provided by current solvers are generally lost as a result of these complexities. Many integration decisions rely on additional considerations not previously modelled in the solver (e.g., sensor types and costs, external geometry variations, lighting conditions, non-stationary installations) and rerunning the solver with additional constraints is necessary, resulting in an inefficient and ineffective decision-making process. Furthermore, the synthesis of distinct solutions is only applicable to stationary inspection applications (i.e., the sensor placement is fixed relative to the part), and is unable to be effectively utilized to capture continuous inspection data for more flexible mobile inspection applications (i.e., the sensor placement is able to move relative to the part).

Early attempts at solving the sensor deployment problem (more widely referred to in the literature as the optimal camera placement (OCP) problem [1]) (Note: numbers in square boxes are used herein to indicate reference documents, a list of which are provided at the end of this disclosure) date back to the 1980s ([2], [3]), but the background really began to resemble its current form in the 1990s ([4]-[8]). These early works established important aspects of the problem such as sensor constraint modelling ([4]), environmental effects such as ambient or directed lighting ([5], [6]), and geometric occlusions ([2], [4], [6]). However, these works tended to use simple “generate and test” methodologies for camera placement solutions, in which potential sensor configurations are suggested based on simplified representations of constraints and then tested against each other until one is found which maximizes a given performance metric ([1], [2], [4], [5]).

While the underlying framework of the problem laid out in these early works has remained unchanged, modern art has updated and refined the elements in order to improve overall performance. Updates to sensor modelling ([9]), sensor constraints ([10]-[12]), and occlusion testing ([13], [14]) have contributed to the ability to more completely describe the problem, but the conclusive solving of the camera placement solution remains elusive. Most modern problems attempt to synthesize solutions using metaheuristic optimization methods, including genetic algorithms ([11], [15]), particle swarm optimizers ([16], [17]), simulated annealing ([18]), and differential evolution ([19]), and while these methods have delivered some promising initial results, they leave significant room for improvement. Because of their metaheuristic nature, these methods are unable to certify the optimality of solutions, and their results are not repeatable; given several sets of identical initial problem conditions and constraints, the methods will not always return identical results. Furthermore, adding new problem constraints is time-consuming and difficult, often requiring an expert on the chosen method.

Some modern efforts also attempt to solve the sensor deployment problem by combining the aforementioned methods with methods from set theory used to solve the set coverage problem ([20]-[22]). The set coverage problem is one which, given a set of elements, attempts to find the smallest subset of these elements whose union equals the entire set ([23]). This is relevant to the OCP, as many modern methods, including the method proposed herein, use 3D representations of parts that are composed of sets of tessellated triangular facets. Thus, a solution could be found by examining the set of all possible camera poses and solving for the subset in which each facet is visible. Local search ([24]), Lagrangian heuristic ([25]) and greedy search ([26]) based methods have been developed from traditional set coverage solving methods, but their performance does not match newer meta-heuristic methods. These newer methods include ones based on genetic algorithms ([27]), ant colony optimizers ([28]), and particle swarm optimizers ([29]), among others. While newer methods can nominally obtain best-known solutions to benchmark set coverage problems ([30]-[32]), they still rely on meta-heuristics which are unable to certify the optimality or reliability of their solutions. Additionally, because they were not developed within the context of the optimal inspection problem, it is likely that they would require adaptation in order to solve the specific set coverage problem that arises in that context.

The current state of the background art, overall, is one in which there are several tools suggested for the solving of the OCP, but none of which are able to reliably arrive at a certified set of solutions.

In summary, many efforts have been made in the field of industrial machine vision to attempt to solve the camera deployment problem—deciding where to place cameras, how to orient them, and how to ensure that these deployments will be able to accurately carry out the required machine vision inspection task required. These efforts have been mostly academic and have relied on over-simplified geometry, unrealistic assumptions, or impractical heuristic optimization routines, all of which made for results which were not practically applicable in today's factory environments.

Known automated solutions generally try to solve the sensor deployment problem by synthesizing the poses of one or more sensors using heuristic-based approaches and stochastic optimization tools to determine one or more sensor deployment solutions that satisfy the inspection constraints for the entire part. For the majority of part geometries, the inspection constraints result in a multimodal optimization problem with many possible solutions and most optimization approaches can prematurely converge to solutions that are non-optimal (e.g., does not provide the minimum number of sensors, the cost of selected sensors is not minimized, etc.). Furthermore, the existing synthesis approaches rely on a discretization of the pose space and therefore restrict their output to a finite number of discrete sensor pose solutions; however, there is a set of pose solutions that satisfy the inspection constraints. The discretization enforced with conventional theoretical schemes cannot reliably evaluate these sets of solutions and therefore, existing approaches can only provide a sample of these solutions. As well, any changes to the inspection constraint, such as additional external geometries that were not considered or additional sensors, requires the sensor deployment problem to be reevaluated, costing additional time and resources to adapt the problem formulation to handle new constraints.

Accordingly, there is a need for a system and method that enables effective camera deployment solutions for industrial and other applications.

### SUMMARY

According to a first example aspect is a computer implemented method for computing a camera deployment solution for an inspection task within an environment, including: obtaining a set of data that includes: (i) a 3D-mesh model of a part to be inspected, the 3D-mesh model defining surfaces of the part as a mesh of facets; (ii) a first camera description that specifies multiple imaging properties of a first camera; and (iii) environment data indicating one or more physical characteristics of the environment; defining, based on the set of data, an initial camera pose space for a first facet of the mesh of facets, the initial camera pose space comprising a set of initial camera pose intervals, each initial camera pose interval being defined by a set of minimum and maximum pose boundaries within the environment; performing an iterative loop, based on the initial camera pose space and the first camera description to compute a final camera pose space comprising a set of one or more final camera pose intervals, wherein each of the final camera pose intervals specifies a respective set of minimum and maximum pose boundaries for the first camera within the environment that enable the first camera to capture an image of the first facet that satisfies a set of defined inspection task constraints; and selecting one or more of the final camera pose intervals of the final camera pose space for inclusion in the camera deployment solution.

### BRIEF DESCRIPTION OF THE DRAWINGS

Reference will now be made, by way of example, to the accompanying drawings which show example embodiments of the present application, and in which:

FIG. 1 is a block diagram illustrating a possible configuration of an industrial process that incorporates image analysis.

FIG. 2 is a flow diagram illustrating operation of the camera deployment solver module according to example embodiments.

FIG. 3 shows an example of a perspective view of a 3D mesh model of an object that may be considered by a machine vision inspection solution.

FIG. 4 shows an illustration of an inspection space associated with a given facet of a 3D mesh model and a given camera description.

FIG. 5 illustrates a perspective view of a 3D mesh model showing sets of inspectable, non-inspectable, and partially-inspectable facets corresponding to a given set of camera poses.

FIG. 6 shows a set of camera pose intervals representing a camera deployment space.

FIG. 7 is a block diagram of a processing unit on which one or more modules of the present disclosure may be implemented.

FIG. 8 is a flowchart illustrating operations performed to determine an inspection space.

FIG. 9 shows an example of an interval analysis constraint evaluation result.

FIG. 10 is an example pseudocode representation of an interval-based constraint solver algorithm, according to a third example embodiment.

FIG. 11 illustrates an orientation rotation sequence.

FIGS. 12A, 12B, 12C and 12D are block diagrams showing an example of an occlusion testing operation.

FIG. 13 is an example pseudocode representation of an algorithm for determining if a facet is occluded.

FIG. 14 is an example pseudocode representation of an overall algorithm for determining a set of inspection poses for a single facet.

FIG. 15 is a flow diagram illustrating an example of a camera deployment solver module according to a fourth example embodiment.

FIG. 16 is an example pseudocode representation of a multi-facet position solver algorithm performed by the camera deployment solver module of FIG. 15.

FIG. 17 is an example pseudocode representation of a multi-facet orientation solver algorithm performed by the camera deployment solver module of FIG. 15.

FIG. 18 is an example pseudocode representation of a single camera deployment recommendation algorithm performed by the camera deployment solver module of FIG. 15.

FIG. 19 is an example pseudocode representation of a multi-camera deployment recommendation algorithm performed by the camera deployment solver module of FIG. 15.

FIGS. 20A, 20B and 20C illustrate a set of equations that relate to the fourth example embodiment.

FIG. 21 illustrates a thin lends model according to example embodiments.

Similar reference numerals may have been used in different figures to denote similar components.

### DESCRIPTION OF EXAMPLE EMBODIMENTS

This disclosure provides systems and methods for addressing the camera deployment problem by leveraging the capabilities of interval analysis and set-based constraint formulation and satisfaction to develop a system for the synthesis of valid inspection poses for machine vision-based inspection of arbitrary objects. The disclosed systems and methods can, in at least some scenarios, account for realistic camera models and non-linearities and uncertainties present in an inspection task and corresponding camera deployments to allow for real-world industrial camera deployment.

An inspection task can be generally defined as a “measurement, or set thereof, to be performed by a given sensor on some features of an object, for which a geometric model is known”. In the present disclosure, the inspection task can be defined as the surfaces of the part that need to be acceptably imaged to perform a suitable inspection. In examples, a method for planning an inspection task is based on a known geometric model of the object and a set of inspection constraints that define valid inspection criteria for a given inspection camera.

The present disclosure proposes a fundamental reformulation of the sensor deployment problem and derive sets of valid sensor deployments by considering the ‘inspection spaces’associated with the inspection facets of a mesh representation of a part (also referred to herein as an object). An inspection space defines the set of acceptable sensor poses (i.e., positions and orientations) that satisfy the inspection constraints for a considered region of the part. As will be described below. In example embodiments, inspection task and inspection space are considered at the level of a single facet of interest (“foi”), also referred to herein as an inspection facet. For each inspection facet, an associated inspection space is derived using set-based computation tools, such as interval analysis, by formulating and considering the sensor-related constraints (e.g., facet visibility and occlusion, resolution, focus, lens-related distortions, distance, surface normals, etc.). Sensor pose bisection and facet subdivision strategies allow refining the performance of a camera deployment solver while certifying the accuracy of the computations.

According to example embodiments, the inspection space solutions associated with multiple inspection facets can be intersected to identify all certified candidate deployment solutions. This provides a convenient and flexible description to easily identify deployment solutions with: a minimal numbers of sensors (optionally considering various sensor types), a range of valid deployment locations to provide the integrator with many valid options while also handling installation uncertainties, and various part geometry considerations (e.g, dimensional instability). This approach can be used for unknown part geometries by utilizing additional sensors and techniques to perform a 3D surface reconstruction of the part. Furthermore, the inspection space solutions can be utilized to plan the sensor trajectories for mobile part inspections in real-time online inspection scenarios.

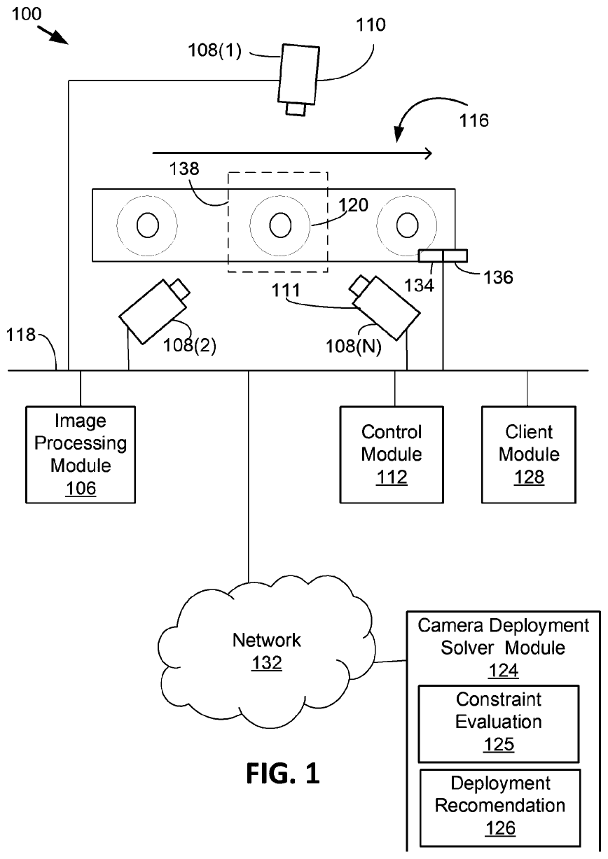

By way of context, FIG. 1 depicts a system 100 that incorporates image analysis for industrial process applications. In example embodiments, the elements of system 100 include one or more cameras 108(1) to 108(N) (reference 108 is used to denote a generic individual camera 108 in this disclosure), image processing module 106, control module 112, camera deployment solver module 124 and client module 128. As used here, a “module” and a “unit” can refer to a combination of a hardware processing circuit and machine-readable instructions and data (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit.

In example embodiments, cameras 108(1) to 108(N), image processing module 106, process control module 112 and client module 128 may be located at an industrial process location or site and enabled to communicate with an enterprise or local communications network 118 that includes wireless links (e.g. a wireless local area network such as WI-FI™ or personal area network such as Bluetooth™), wired links (e.g. Ethernet, universal serial bus, network switching components, and/or routers, or a combination of wireless and wireless communication links. In example embodiments, camera deployment solver module 124 may be located at a geographic location remote from the industrial process location and connected to local communications network 118 through a further external network 132 that may include wireless links, wired links, or a combination of wireless and wireless communication links. External network 132 may include the Internet. In some examples, one or more of control module 112, image processing module 106, process control module 112, and client module 128 may alternatively be distributed among one or more geographic locations remote from the industrial process location and connected to the remaining modules through external network 132. In some examples, camera deployment solver module 124 may be located at the industrial process location and directly connected to local communications network 118.

In some examples, control module 112, image processing module 106, process control module 112, camera deployment solver module 124 and client module 128 may be implemented using a suitably configured processor enabled computer devices or systems such as personal computers, industrial computers, laptop computers, computer servers and programmable logic controllers. In some examples, individual modules may be implemented using a dedicated processor enabled computer device, in some examples multiple modules may be implemented using a common processor enabled computer device, and in some examples the functions of individual modules may be distributed among multiple processor enabled computer devices. Further information regarding example processor enabled computer device configurations will be described below.

In example embodiments, cameras 108(1) to 108(N) can include one or more types of cameras including for example thermal image cameras and optical image cameras. For example, one or more of the cameras 108(1) to 108(N) may be a thermal image camera 111 that is a processor enabled device configured to capture thermal data by measuring emitted infrared (IR) or near infrared (NIR) radiation from a scene and calculate surface temperature of one or more objects of interest (e.g., parts) within the scene based on the measured radiation. Each thermal image camera 111 can be configured to generate a structured data output in the form of a thermal image that includes a two-dimensional (2D) array (X,Y) of temperature values. The temperature values each represent a respective temperature calculated based on radiation measured from a corresponding point or location of an observed scene. Thus, each thermal image includes spatial information based on the location of temperature values in the elements (referred to as pixels) of the 2D array and temperature information in the form of the temperature value magnitudes. By way of non-limiting example, each thermal image may have a resolution of X=320 by Y=256 pixels that are each assigned a respective calculated temperature value, although other resolutions can alternatively be used. Each thermal image camera 111 may generate several thermal images (also referred to as frames) per second. By way of non-limiting example, each thermal image camera 111 may scan 60 frames per second, with each frame being an X by Y array of temperature values, although other frame rates may also be used. In some examples, the calculated temperature values included in a thermal image may be a floating point temperature value such as a value in degrees Kelvin or Celsius. In some examples, each pixel in a thermal image may map to a desired color palette or include a respective color value (for example an RGB color value) that can be used by a display device to visually represent measured thermal data.

In some examples, one or more of cameras 108(1) to 108(N) can be an optical image camera 110 configured to capture a representation of visible light reflected from a scene that can include one or more objects of interest. Each optical image camera 110 can be configured to generate a structured data output in the form of an optical image that includes two-dimensional (2D) image data arranged as an (X,Y) array of picture elements (e.g., pixels), where each array element represents an optical image data value such as a color value. Each array element may have multiple depths or channels, with each depth representing a respective color value (e.g., Red-Green-Blue (RGB) values in the case of an RGB format, or Hue-Intensity-Saturation (HIS) in the case of an HIS format). In some examples, optical image camera 110 may be a monochrome image sensing device or a grayscale image sensing device. The pixel values included in the optical image data each represent respective visible light properties calculated based on reflected light from a corresponding point or location of an observed scene. Thus, each optical image frame includes geospatial information based on the location of the values in the pixels of the 2D array, and optical data. Each optical image camera 110 may be configured to generate several optical images (also referred to as frames) per second, with each frame being an X by Y array of optical data values.

In example embodiments, cameras 108(1) to 108(N) are selected and arranged according to a predetermined camera deployment solution to capture a scene that includes at least one component or part 120 (e.g., a manufactured part 120 that is produced as one of a sequence of identical parts in an industrial process 116) such that the images captured by sensor devices 108(1) to 108(N) includes image data about the manufactured part 120.

In example embodiments, image processing module 106 is configured to receive image data from cameras 108(1) to 108(N) about the part 120 in the form of thermal images from one or more thermal image cameras 111, and/or optical images from one or more optical image cameras 110. Each thermal image provides a set of 2D pixel-level thermal texture data for the part 120, and each optical image provides a set of 2D pixel-level optical texture data for the part 120.

Control module 112 is configured to receive image data from image processing module 106, process the received image data, and take actions based on such processing. In some examples, the actions may include an inspection decision, such as classifying the part 120 as passing or failing a quality standard. In some examples, the actions may include generating control instructions for one or more industrial processes 116 that are part of the system 100. In some examples, the control instructions may include instructing process control unit 136 to physically route a manufactured part 120 based on a classification (e.g., “pass” or “fail” determined for the part 120.

In some examples, control module 112 may include one or more trained machine learning (ML) based models that are configured to perform the processing of the rendered image data.

Client module 128 may be configured to allow users at the industrial process location to interact with the other modules and components of system 100.

As will now be described in detail, camera deployment solver module 124 is configured to support an initial deployment of the cameras 108(1) to 108(N) for the system 100. In particular, camera deployment solver module 124 is configured to generate a customized camera deployment solution that can indicate answers to questions such as: (i) The number of cameras required; (ii) The camera type(s) (make and model) and lens type(s) (make and model); and (iii) The relative pose (position and orientation) of the camera(s) to a part or region-of-interest.

The configuration and functionality of camera deployment solver module 124 will now be described in greater detail in accordance with example embodiments. In at least some examples, camera deployment solver module 124 provides an automated tool for machine vision deployments to aid integrators and engineers in selecting the correct hardware for the task, integrating the hardware into the manufacturing line appropriately, and configuring the hardware to meet the task requirements. As will be explained in greater detail below, camera deployment solver module 124 addresses the gaps in available solutions by analyzing and synthesizing camera deployment solutions for the inspection of any selected facets of any arbitrary part mesh that satisfy all associated imaging and task constraints. Camera deployment solver module 124 includes tools for performing two processes: a constraint evaluation process 125 and a deployment recommendation process 126.

The constraint evaluation process 125 makes use of detailed mathematical camera models which accurately capture the imaging characteristics of a given camera (eg. zoom, focus, depth of field, field of view, lens distortions, etc.) to formulate a set of associated pose-based constraints. In example embodiments these constraints are functions of camera pose intervals. A valid camera pose interval is a set of camera poses that, when evaluated with the constraints, yield results contained with the upper and lower constraint limits such that the camera performs sufficiently well on the given inspection task. Likewise, an invalid camera pose interval is a set of camera poses that, when evaluated with the constraints, yield results outside of the upper and lower constraint limits. Lastly, a partially valid camera pose interval is a set of camera poses that, when evaluated with the constraints, yield results that are both inside and outside of the upper and lower constraint limits.

A camera pose can be described by a six-dimensional vector whose components are the 3D positions (X,Y,Z) and 3D rotation (eg. yaw, pitch, roll Euler angles). In the illustrated example, a camera pose interval (also referred to herein as a “box”) is described by 6-dimensional interval vector whose elements are intervals, where each interval describes a set of values between lower and upper bounds (eg. [X]=[Xmin, Xmax]).

For a given object 120 and camera 108 and pose, a set of constraints can be evaluated. If all constraint evaluations remain between the upper and lower limits, the camera 108 satisfies the set of constraints and the part 120 is imaged sufficiently well. For example, this can mean that any surfaces of the part 120 that need to be inspected will be entirely captured in the image, will be in focus, and will be un-occluded by any external geometries.

By defining a part as a 3D tessellated mesh composed of triangular facets, it is possible to test whether or not any particular facet falls entirely within the valid imaging region for a camera with any given pose. Based on this relationship, constraint analysis process 125 applies an interval analysis-based branch and bound constraint satisfaction process which iteratively evaluates camera imaging constraints to develop a hierarchical tree structure containing all camera pose solutions from which at least one facet is suitably inspectable. The resulting set of camera pose solutions is referred to herein as a solution list (Ls).

The solution list (Ls) provided by constraint evaluation process 125 can enable the deployment recommendation process 126 to generate informed recommendations regarding camera deployments. Additionally, because the poses are derived using interval-based methods, it is possible to certify their accuracy and provide tolerances on installation recommendations. The constraint evaluation process 125 has an inherent ability to account for uncertainties, making it possible for deployment recommendation process 126 to generate realistic camera deployment solutions without an unachievable precision requirement and still certify the accuracy of the results indicated in the solution list (Ls).

Camera deployment solver module 124 can, in some scenarios, provide solutions to the problem of camera placement for industrial machine vision tasks. The solutions can be complete, rigorous, certifiable solutions that are readily and practically applicable. Use cases, while focused on inspection tasks in this disclosure, could also include camera placement for observation or security monitoring, deployment of sensors, tool path planning in robotics, design of lighting arrays, and various other open-ended deployment and configuration problems for sensors, tools, or robots in industrial facilities.

### First Example Embodiment

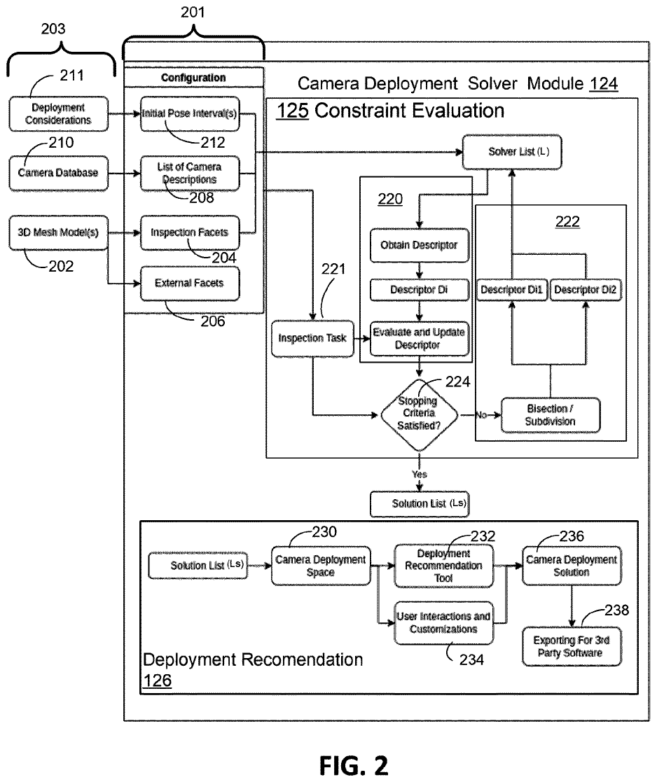

FIG. 2 is a flow diagram illustrating operation of the camera deployment solver module 124 according to a first example embodiment.

In the illustrated example, the deployment solver module 124 receives a set of input data 203 that is processed to generate solver configuration data 201, as described below.

The input data 203 includes a model 202, a camera database 210 (also referred to as a sensor list), and a set of deployment considerations 211, as described in greater detail below. Solver configuration data 201, which can in some examples be computed based on or derived from input data 203, can include: a set of initial pose intervals 212; a list of camera descriptions {C1, C2, C3 . . . }208; a list of inspection facets 204; and a list of external facets 206, each of which are described in greater detail below.

The model 202 is a 3D representation of the geometric structure of the part to be inspected (e.g., part 120). In example embodiments, the model of object is a 3D mesh model 202 that defines a number of facets and corresponding vertices. Any object, flat or three-dimensional, may be converted from its original computer-aided-design (CAD) digital format to an approximate 3D mesh model format, such as Standard Tessellation Language (STL) that describes the object as a mesh, or tessellation, of polygons. In the illustrated example, a triangle mesh representation is used. Triangle mesh is a specific type of polygon mesh commonly used in computer graphics and represents a given object geometry as a triangular mesh with edges, faces and vertices that define a 3D structure of object surfaces. The mesh comprises a set of triangles (typically in three dimensions) that are connected by their common edges or vertices. Each triangle in the mesh is referred to as a facet. Each vertex in the mesh is described as a set of 3D coordinates, and these coordinates are compiled in a list of vertices. Each triangular facet is then described as a set of three vertices (edges are described by a set of two vertices). Additionally, each vertex and face has an outward facing normal vector assigned to it.

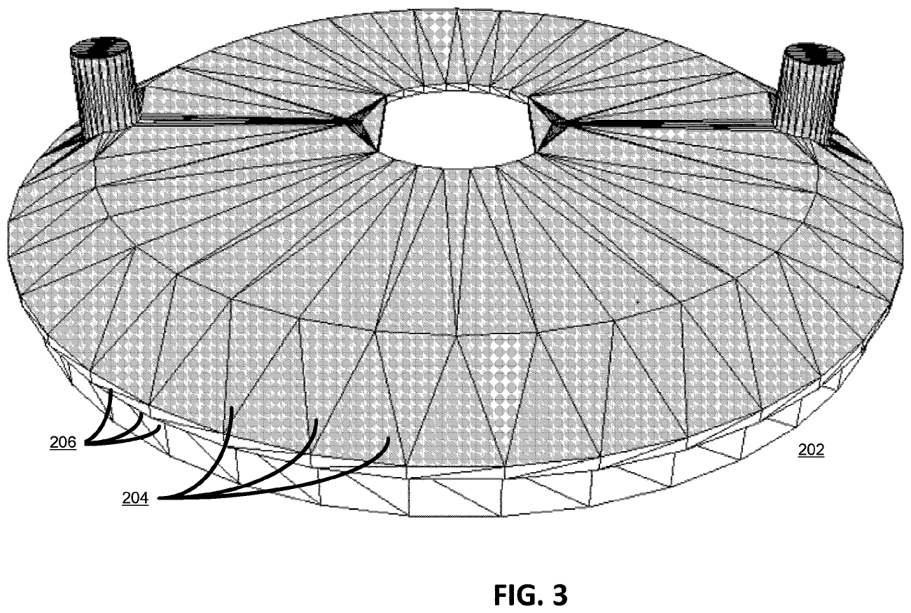

FIG. 3 shows a graphic representation of an example of a 3D mesh model 202 of a part 120 that may be considered by a machine vision inspection solution. The 3D mesh model 202 can be automatically computed algorithmically from a CAD digital format based on user-defined conversion parameters to closely approximate curved surfaces.

In some examples, the facets that are described by the 3D mesh model 202 can each be categorized as either an “inspection facet” or an “external facet”. The desired inspection surface of the object 202 under investigation for an inspection task is described by a specific set of inspection facets 204. The inspection facets 204 are the facets of interest that must be inspected. External facets 206 specify facets of the part 120 and/or environment that do not necessarily need to be inspected. By way of illustration, inspection facets 204 in FIG. 3 are indicated with shading and correspond to regions of the object 202 that must be inspected with a machine vision solution, and external facets 206 (for example, shown at a lower rim of object 202) are indicated without shading.

In some examples, during system configuration, a user can be presented with a representation of 3D mesh model 202 via a graphical user interface (GUI) and be given an opportunity to provide inputs to select or unselect regions of facets or individual facets of the part 120. The selected facets are included in the list of inspection facets 204 and the unselected facets 206 are included in the list of external facets 206. In at least some examples, all facets that correspond to external objects (e.g., facets of external objects described in the list of deployment considerations 211) within the workspace can also be included in the list of external facets 206. In some examples, all facets of the part 120 of interest are included by default in the list of inspection facets 204 unless indicated otherwise by a manual user process or an automated process. Since a facet can be recursively subdivided, the 3D mesh model 202 can be adapted to accommodate any desired inspection surface.

Camera database 210 is a database that describes a variety of machine vision hardware options that is available for an inspection task. In one example, camera database 210 includes a list of sensors (e.g., cameras) and a respective camera description Ci for each camera 108(i) (also referred to as a camera model). The camera description Ci can be used to determine imaging constraints that indicate if a camera 108(i) can image a particular facet in a triangular mesh. In some examples, a subset of the camera descriptions {C1, C2, C3 . . . } are selected from the camera database 210 to provide a list of camera descriptions 208 that are considered by the camera deployment solver module 124 when computing camera deployment solutions.

In example embodiments, the camera description Ci for a camera 108(i) is given by the calibrated camera intrinsic corresponding to realistic mathematical models of the camera sensor and lens and can, for example, specify the following parameters: (i) focal length, ƒ; (ii) ratio of focal length ƒ to aperture diameter a_{diam}, namely aperture setting ƒₛₜₒₚ; (iii) relationship between locations of the camera lens focal plane and film plane, denoted as d′_{focus}; (iv) image blur, which can be based on one or more of camera focus and limits on the acceptable image blur, and may for example be described using a blur angle θ; and (v) sensor parameters such as pixel pitch and number of pixels (e.g., sensor size and resolution).

In some examples, a user can interact with the camera database 210 of calibrated camera models (camera intrinsics) of a variety of available machine vision hardware to configure the camera deployment solver module 124, whereby users may: select any number of camera options to use as camera descriptions within the camera deployment solver module 124; provide one or multiple camera descriptions to the camera deployment solver module 124; incrementally add new camera descriptions to the camera deployment solver module 124 to explore other deployment options.

The set of deployment considerations 211 (also referred to as an environment or workplace model) can, among other things, specify physical limitations on where cameras can be positioned in an environment or workspace (e.g., available camera mounting locations) and the locations of external objects within the workspace that can block camera views. External objects (e.g. manufacturing lines, robots, cables, etc.) can have significant impact on the resulting camera deployment solutions. These external objects can, for example, also be described as respective 3D mesh models, where each facet of each model is considered by its impact on the inspectability of the facets on the object under investigation. The location of these external objects can, for example, be specified as coordinates in a reference coordinate system, for example a world coordinate frame F_{w}, whose origin is a user defined origin of the workspace.

As part of system configuration, as set of initial pose intervals 212 can be defined within the workspace based on the set of deployment considerations 211.

For a given camera deployment, a point on the surface of 3D mesh model is said to be inspectable if all associated inspection constraints (i.e., imaging constraints and task constraints) are satisfied for that point. Similarly, the inspectable surface of a given part is the set of all points on the surface of 3D mesh model that satisfy all imaging and task constraints (these inspection constraints are defined by the inspection task 221).

The imaging constraints can include parameters related to: (i) Visibility of the inspection facets. For example, facet visibility in the camera field of view can be based on one or more of the following: Camera intrinsics, lens distortions, occlusions from external facets, F-stop (aperture) settings, and depth of field limits; (ii) Pixel size, which can be based on one or more of pixel pitch, camera resolution constraints, sensor size; and (iii) Image blur, which can be based on one or more of camera focus and limits on the acceptable image blur.

The task constraints can include parameters related to: (i) Angle of incidence constraints (eg. to account for external lighting, reflections, and emissivity variations of IR cameras) and (ii) Camera pose constraints (e.g., pose restrictions imposed by camera mounting to specific surfaces or brackets).

Solving for the appropriate depth of field for a given camera/lens pair is a well established process when the lens zoom and aperture settings are fixed to constant values. However, determining the depth of field for continuous settings is less trivial, and involves a novel continuous set-based formulation. The formulation in this disclosure is beneficial as it is commonplace for industrial cameras to feature variable zoom and aperture settings, and ensuring that they are set correctly for the task is critical for achieving an image in which the part is suitably in focus. Using interval analysis and the intervals containing the range of possible aperture settings and working distances, the novel constraint parameter generation routine creates a depth of field constraint which, rather than specifying fixed lens settings for a given pose, certifies that if the object is placed within the appropriate depth of field range, there will be a set of lens settings at which it will be imaged suitably sharply.

Additionally, according to example implementations, the camera orientations are solved for a given mesh facet such that the algorithm can certify that the given facet is fully contained in the camera's field of view for all of the orientations contained in a given pose interval. This is formulated using a manipulation of pose boxes and interval-based contraction to certifiably solve for the complete set of valid orientations for a given camera-facet pair, and results in a novel process for solving allowable orientations for inspection poses in a continuous set-based framework.

Finally, mapping the 3D world position of an object to its 2D projection onto the image plane of an observing camera and accounting for the effect of lens distortions in this process is also a well defined problem when using discrete points and camera poses. However, when considering this mapping in the context of a continuous set of poses where each results in a slightly different distorted projection onto the image plane, the existing methods proved insufficient. Again, this disclosure leverages interval extensions, interval analysis methods, and incorporates manipulations from the orientation constraints in order to certify that an object's projection onto the image plane of a camera falls entirely onto the camera's image sensor from any pose within a given 6D interval.

The objective of a camera deployment solver module 124 is to synthesize the camera deployment solution(s) that result in a desired inspection surface being a subset of the inspectable surface. That is, a camera deployment solution ensures that the inspectable surface includes the desired inspection surface.

The constraint evaluation process of camera deployment solver module 124 leverages a set-based approach to compute the inspection space (the complete set of camera pose solutions that accomplish the task) for each inspection facet of the 3D mesh model of the object under investigation corresponding to a given camera description. A core function of operation of deployment solver module 124 is to define an inspection space. An inspection space as used herein means the region in 6-dimensional (6D) pose space (3 dimensions describing sensor position, 3 dimensions describing sensor orientation) for which all inspection constraints for a given facet of a 3-dimensional geometry to be inspected are satisfied. This ensures that any image taken from within this inspection space will not only contain the facet of interest but also that it will be imaged with sufficient quality for an accurate inspection to be made.

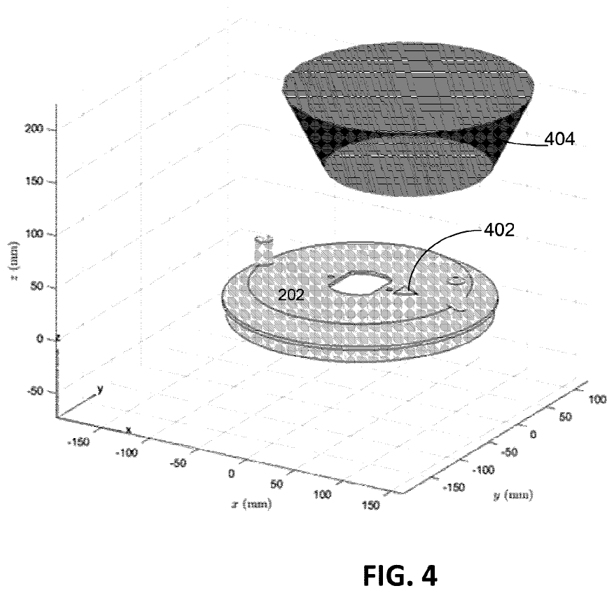

For example, FIG. 4 shows an illustration of the inspection space 404 (shown as a frusto-conical region) associated with a given facet 402 of the 3D mesh model and given camera description. A facet cannot be inspected by that camera unless its pose is contained within the inspection space 404.

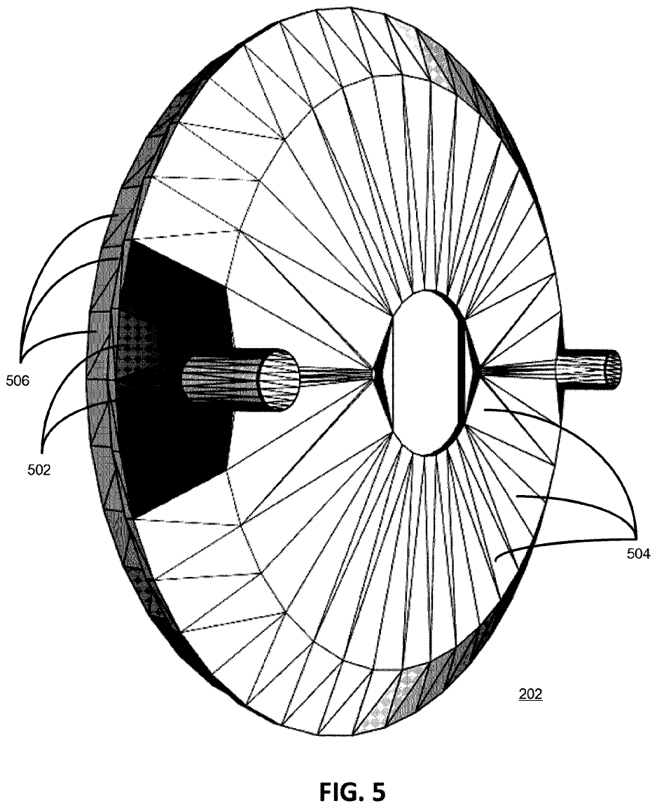

In this regard, for a given camera pose interval, the associated set of inspectable, uninspectable, and partially-inspectable facets (subset of inspection facets in the 3D mesh model) are computed. By way of example FIG. 5 illustrates the sets of inspectable facets 504 (white), non-inspectable facets 506 (light grey shaded, along rim), and partially-inspectable facets 502 (dark grey shaded) facets corresponding to a given set of camera poses.

The properties of interval arithmetic enforce that: (i) Every pose in the pose interval is able to inspect each inspectable facet; (ii) Every pose in the pose interval is unable to inspect each uninspectable facet; and (iii) At least one pose in the pose interval is unable to inspect each partially-inspectable facet.

Based on the task and inspection constraints, the outer limits on the set of camera poses can be determined. An initial pose interval [P] is defined by the outer limits of the set of relevant camera poses.

The camera deployment solver module 124 leverages a branch-and-bound strategy to consider the initial pose interval(s) [P] and evaluate the inspectability of each facet for that pose interval [P]. For a given pose interval [P], each facet has four possible classifications (0: unclassified, 1: inspectable, 2: uninspectable, 3: partially-inspectable).

By way of overview, and with reference to FIG. 3, in example embodiments, input data 203 is processed to provide a set of configuration data 201 for the camera deployment solver module 124. Based on this data, an inspection task 221 is formulated that supports the evaluation of various task constraints and various imaging constraints using set-based formulations and interval arithmetic to evaluate constraint satisfaction. Among other things, camera deployment solver module 124 enables: individual processing units (e.g., pose intervals) that are represented by descriptors; use of hierarchical representations when bisecting or subdividing descriptors to improve performance and reduce memory usage; derivation of parameter-driven constraints that can be customized to any camera description; and derivation of parameter-driven constraints that can be customized to specific task requirements.

Configuration operations of camera deployment solver module 124 operations of may also include providing a software based interface(s) that a user can leverage to upload part models, define inspection considerations, create deployment configurations, and export deployment solutions. In some examples, the user interfaces can support 3D rendering capabilities and allow the user to import part models and external geometries. In some examples, a GUI enables a user: (i) to select inspection facets of the object under consideration by selecting one or more facets corresponding to regions of the object surface that are intended to be inspected. (ii) select one or more camera descriptions that can be used to configure a camera deployment solver; (iii) select or specify external facets to represent facets on the part under consideration or external objects in the environment that can impact the inspection task.

Referring again to FIG. 2, each initial pose interval ([P]) in the set of initial pose intervals 212 provided to the camera deployment solver module 124 has an associated list of unclassified facet classifications (F=(0, 0, 0, . . . )) for each of the inspection facets (i.e., all facets are initially unclassified). The pose and classification group ({[P],F}) form a descriptor Di=({[P],F}). The set of Descriptors corresponding to the set of initial pose intervals 212 are added to a solver list (L).

The constraint evaluation process 125 of camera deployment solver module 124 iterates over each descriptor Di in the solver list L and computes a classification for each unclassified or partially-inspectable facet and updates the classifications in the descriptor Di (Block 220) based on inspection constraints of the inspection task 221. If all classifications are inspectable or uninspectable, the constraint evaluation process 125 is completed with that descriptor Di and it is saved to a solution list (Ls). Otherwise, if any facet has a classification of partially-inspectable, the pose interval [P] is subdivided into two smaller intervals ([P1] and [P2]) by bisecting the pose interval [P] along one dimension (Block 222). The previous descriptor Di is removed and two new descriptors Di1=({[P1],F}) and Di2=({[P1],F}) are added to the solver list (L).

Stopping criteria 224 is incorporated into the constraint evaluation process 125 by limiting the size of the bisected pose intervals. If the width of a pose interval [P] is below a predefined threshold, then that pose interval [P] is not bisected further. Instead the descriptor with partially-inspectable classifications is saved to the solution list Ls. Computational times or maximum number of iterations can also be leveraged as possible stopping criteria.

The constraint evaluation process 125 can be rerun with adjusted stopping criteria to refine the solution list Ls as desired to reduce the partially-inspectable classifications. Additionally, the facets can also be subdivided into smaller facets and the solver can be rerun as necessary. Facet subdivision can also be incorporated into the main solver to provide a fully automated solving pipeline.

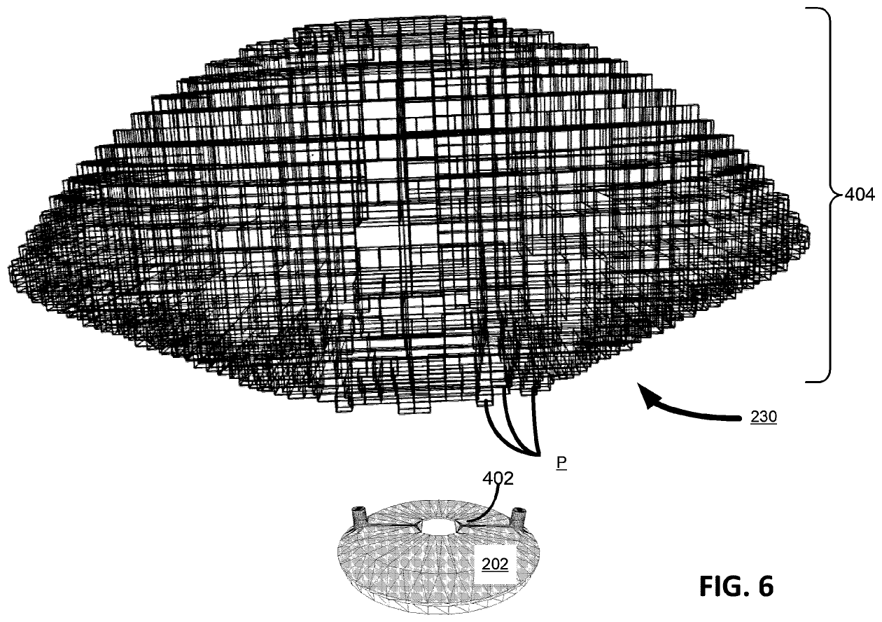

Once the constraint evaluation process 125 is finished, the solution list Ls is returned and processed by a deployment recommendation process 126. The computed solution list Ls is converted to a camera deployment space 230 by computing set intersections of the descriptors. This gives a camera deployment space 230 similar to the example shown in FIG. 6 where each box describes an associated set of camera poses, and the corresponding facet classifications and camera models. For each given pose within the camera deployment space 230, the inspection capabilities of the corresponding machine vision system are understood such that all inspectable facets satisfy the configured imaging and task constraints.

Descriptors with inspectable classifications are isolated to construct deployment solutions. Each descriptor Di in the solution list Ls describes the set of inspectable facets associated with a set of poses (pose interval [P]). The camera deployment space 230 is obtained from the set of camera pose intervals. FIG. 6 graphically illustrates camera deployment space 230 showing the combined pose intervals [P](each pose interval [P] is illustrated a respective box) that result in one or more inspectable facets. Each pose inside the camera deployment space 230 ensures that at least one facet of the inspection facets is inspectable. That is, if a camera is installed according to some pose inside the camera deployment space 230, then it provides an acceptable inspection for some region of the part.

The deployment recommendation process 126 of camera deployment solver module 124 may also consider a set of relevant camera descriptions 208 ({C1, C2, C3, . . . }). For each camera description C, the deployment recommendation process 126 returns an associated camera deployment space 232. Multiple camera deployment spaces 232 can be combined by computing set intersections of the descriptors, providing a camera deployment solution 236. Camera deployment solution 236 can includes a list of descriptors that are updated to include the associated camera descriptions ({[P],F, C}).

An interactive software interface (user interactions and customizations 234) can be provided that provides visuals such as shown in FIG. 6 to assist with interacting with the camera deployment space 230 and enable visualizing of the part, camera deployment space, and possible camera deployment solutions. Users can either interact with the camera deployment space directly and configure their own camera deployment solutions by selecting individual descriptors and adjusting pose and camera models, or users can interface with the camera deployment space through automated deployment recommendation tools that compute optimized camera deployment solutions based on objective function criterion. A user may interact with the camera deployment space 230 to determine the inspectable regions of an object and refine camera selections and placements as desired. Identified camera deployment solutions 236 inherently contain placement tolerances (eg. X=[20, 40] mm=30+/−10 mm) that aid with integration flexibility.

Camera deployment solutions 236 can be recommended based on considerations such as: minimizing the number of cameras, maximizing the inspectable facets for a given camera, and/or minimizing the hardware costs.

Desired camera deployment solutions 236 can be exported in formats that integrate well with 3rd party computer-aided-design software (block 238). This can include, for example: 3D mesh models of the camera(s) in the determined pose(s) relative to the object under consideration; Coloring of the 3D mesh model of the object under consideration according to the facet classifications; Rendered images of the object under consideration from the camera(s) and/or adding geometric features to depict the field of view of the camera(s) (eg. camera frustum) that can be used to visualize occlusions.

Factory floor deployments can leverage automated object pose estimation tools to assist with camera installations, where an augmented reality experience can show the desired part pose in a rendered image that simulates the view from the real camera being deployed. Using this augmented reality experience, combined with real-time object pose estimation, the relative pose of the camera to the part can be computed and necessary camera installation refinements can be easily communicated to the integrator. This can be used to simplify camera deployments in the factory during the integration phase to ensure that the overall camera deployment solution matches what was originally designed.

Camera deployment solver module 124 can also be used for the analysis of existing camera deployment solutions or user specified camera deployment solutions. In this scenario, the initial pose interval is replaced by the exact camera pose and the camera description is replaced by the associated camera being analyzed. Similar to the constraint evaluation process for the synthesis implementation, a descriptor is formed from the inputs and evaluated with the constraint system to determine the classifications of the inspection facets. Since the intial pose interval is already a degenerate interval, further bisection/subdivision is not necessary and the resulting refined descriptor can be immediately returned. This process can be repeated for each camera in the camera deployment solution to evaluate the capabilities of the system in performing the inspection task.

Using the analysis implementation of the camera deployment solver module 124, users can easily interact with camera deployment solutions and adjust them manually to adapt performance to their needs. This allows for a manual design tool for camera deployments whereby users can manually build and refine their desired solutions.

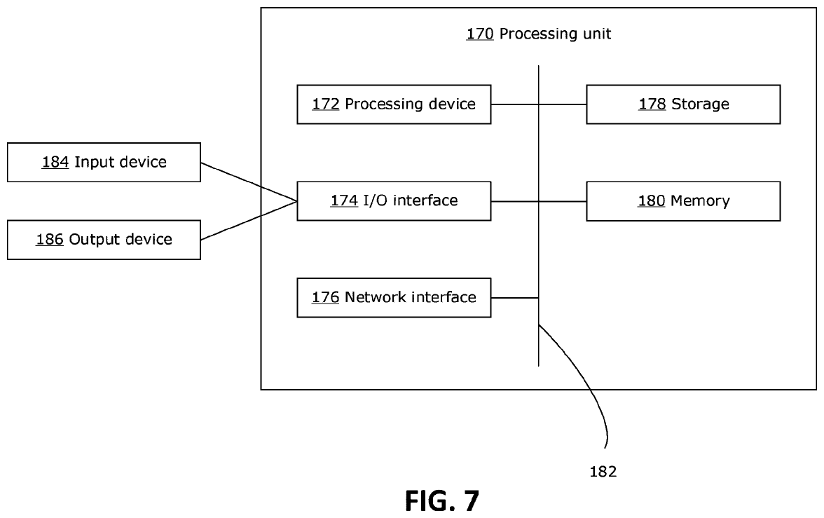

FIG. 7 is a block diagram of an example processing unit 170, which may be used to implement one or more of the modules or units of system 100, including the camera deployment solver module 124. Processing unit 170 may be used in a computer device to execute machine executable instructions that implement one or more of the modules or parts of the modules of system 100. Other processing units suitable for implementing embodiments described in the present disclosure may be used, which may include components different from those discussed below.

The processing unit 170 may include one or more processing devices 172, such as a processor, a microprocessor, a general processor unit (GPU), a hardware accelerator, an application-specific integrated circuit (ASIC), a field-programmable gate array (FPGA), a dedicated logic circuitry, or combinations thereof. The processing unit 170 may also include one or more input/output (I/O) interfaces 174, which may enable interfacing with one or more appropriate input devices 184 and/or output devices 186. The processing unit 170 may include one or more network interfaces 176 for wired or wireless communication with a network (e.g with networks 118 or 132).

The processing unit 170 may also include one or more storage units 178, which may include a mass storage unit such as a solid state drive, a hard disk drive, a magnetic disk drive and/or an optical disk drive. The processing unit 170 may include one or more memories 180, which may include a volatile or non-volatile memory (e.g., a flash memory, a random access memory (RAM), and/or a read-only memory (ROM)). The memory(ies) 180 may store instructions for execution by the processing device(s) 172, such as to carry out examples described in the present disclosure. The memory(ies) 180 may include other software instructions, such as for implementing an operating system and other applications/functions.

There may be a bus 182 providing communication among components of the processing unit 170, including the processing device(s) 172, I/O interface(s) 174, network interface(s) 176, storage unit(s) 178 and/or memory(ies) 180. The bus 182 may be any suitable bus architecture including, for example, a memory bus, a peripheral bus or a video bus.

### Second Example Embodiment

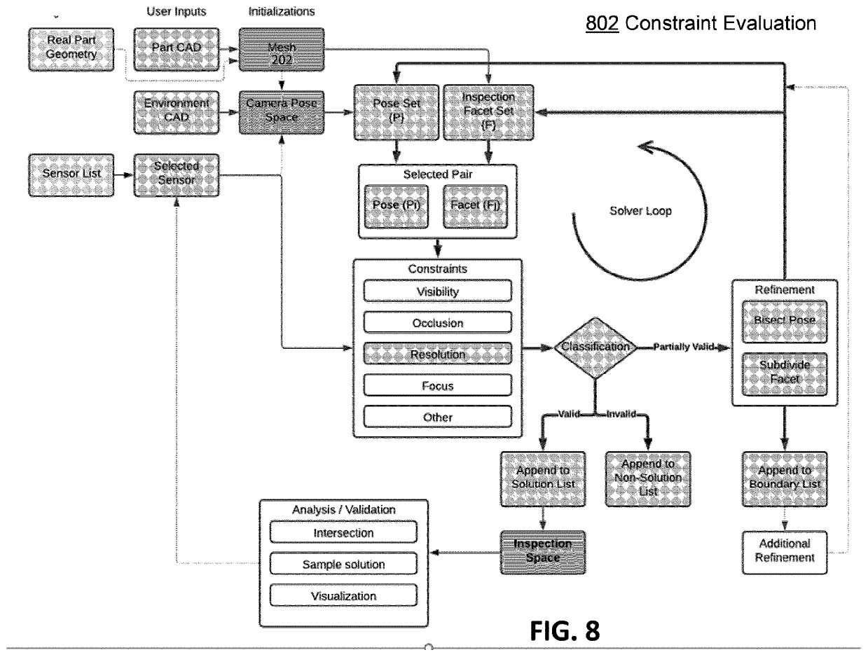

FIG. 8 illustrates another representation of a constraint evaluation process 802 that is similar to constraint evaluation process 125 used to solve for the inspection spaces of each facet according to a further example embodiment.

To begin, the process 802 requires several inputs, which fall into three main groups: part information, environment information (e.g., deployment considerations 211), and sensor information (e.g., camera database 210). The part information elements are the real part geometry, a CAD model of the part, and a corresponding triangular mesh approximation (e.g., 3D mesh Model 202) of the part geometry. The environment information consists of any relevant CAD models, external to the part, that might influence the sensor deployment (e.g., occluding geometries, reflective surfaces, etc.). Consideration of environmental information can help refine the inspection spaces by eliminating any areas where the deployment constraints would be invalid. Finally, the sensor information consists of a list of possible sensors, the desired sensor for the application, and its corresponding parameters. These parameters include focal length, maximum resolution, pixel size, lens distortion, etc., and determine the necessary sensor deployment constraints.

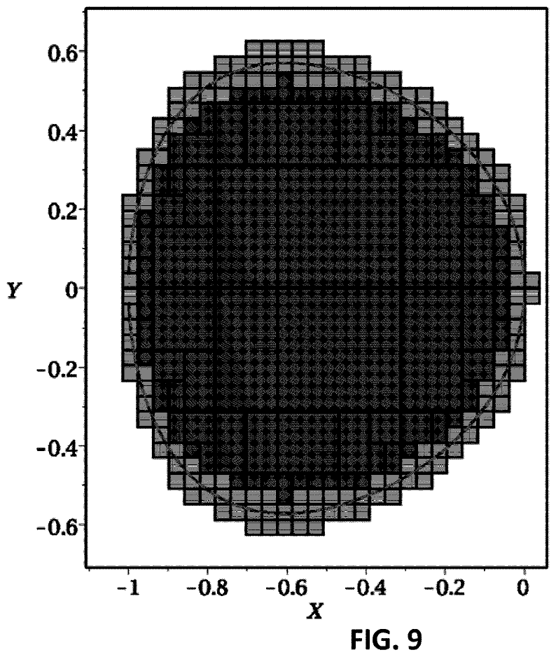

A default pose space (e.g., initial pose intervals 212) is initialized in the form of a 6D box (e.g., pose interval [P]) with arbitrarily large bounds, according to particular application requirements. It is paired with a given facet, and the solving of the inspection space loop begins. First, based on inspection constraints, the arbitrarily large inspection box is contracted using interval methods to reduce its size to a tight bounding box containing all valid solutions. However, this box will also contain some invalid solutions, so further refinement must be done via interval analysis based bisection and classification algorithms. By evaluating the constraints (e.g., facet visibility, image resolution, image focus, occlusion, etc.) on the box, it is possible to determine whether it represents a region in solution space that is a) entirely valid, b) partially valid, or c) entirely invalid. In cases a) or c), the box will be appended to the appropriate solution/non-solution lists. In case b), the box will be bisected into two-component sub-boxes. These will again be associated with the face in question and re-evaluated for constraint satisfaction. This process will iterate until a given stopping criterion is met, which is usually that sub-boxes have become sufficiently small. After this criterion is met, any boxes which are still classified as partially valid will be appended to a list of boundary boxes that represent the areas between the valid and invalid spaces. FIG. 9 shows a simple 2D visualization of the end result of this search algorithm in which valid solutions are represented as darker grey boxes, boundary solutions as lighter grey boxes, and invalid solutions comprise the rest of the window. Note that some boundary solutions require additional refinement to be properly classified, due to characteristic properties of interval analysis.

During the course of the constraint evaluations, if it is found that a given facet has no valid solutions, a routine is invoked which will subdivide this facet into two or more sub-facets. This is done in order to minimize the non-observable surface area of the part in order to return the best results possible.

Once an inspection space has been formulated for each facet of the part, this list of inspection spaces can be used to solve for the optimal camera deployment solution for the entire geometry. Much like the set coverage problem, this problem involves identifying the subset of inspection spaces that allow for all facets to be covered with a minimum number of cameras. Other considerations may also be appropriate (e.g., allowing redundancy, reducing cost, reducing the numbers of different sensors, etc.).

This disclosed solver addresses the failures of the existing art in several ways. Principally, by applying set-based methods via interval analysis to solve for the valid inspection spaces, this approach can rigorously certify that it has solved for the complete set of valid inspection space solutions for any given facet at the desired resolution, considering the specified stopping criteria. Analysis of these inspection spaces allows proposing multiple equally valid sensor deployments, possibly satisfying optimality criteria (e.g., minimizing the number of sensors, minimizing costs) providing significant flexibility for deployment. For example, exact installation specifications are not enforced and the installer can place the sensors anywhere inside the set of solutions and be confident that it will perform appropriately. Additionally, because the methods are deterministic, the results are repeatable and the method ensures that any user applying the solver with the same geometry and constraints will get the same results. Further, extra constraints can be imposed on the inspection spaces after the generation of the initial solution without losing any solutions or wasting additional time and resources to recompute solutions.

The disclosed embodiments go beyond certifications of optimality and repeatability. The specific formulation using set-based methods also addresses several real implementation concerns which existing art does not, allowing this work to transition from an academic exercise into a tool that can be applied to real inspection processes. The first improvement lies in the form of the solutions themselves. Because the valid sensor deployment regions are intervals, as opposed to discrete solutions, they make the physical implementation of the solution feasible. It is infeasible to position a sensor at an exact location with an exact orientation in real inspection scenarios; however, it is feasible to position it within a given set of bounds on the pose. This is also appealing in that it allows for this inexact positioning while still ensuring that image quality standards will still be met, which existing methods cannot match.

Another improvement is that since the solver considers the geometry of the surrounding environment, it allows the user to guarantee that any solutions found by the solver will be feasible to implement in the real factory space. This may seem trivial, but because existing meta-heuristic methods do not consider the external environment, it is likely that they synthesize a solution that demands a sensor be placed in a location that simply is not feasible (i.e. inside a wall, in the path of other machinery, etc.). The interval-based structure of the solver also allows for much easier formulation and application of inspection and environmental constraints. This is a significant advantage over existing methods, as formulating and implementing constraints for meta-heuristic optimizations (particularly the more complex types of constraints inherent to this specific problem) generally requires a significant degree of expertise, and even with that expertise is still a relatively complex undertaking. This constraint flexibility allows users to generate multiple solutions considering a large variety of possible constraints with ease until they arrive at the solution which best suits their specific needs.

The proposed solution also easily allows a number of powerful extensions to the core solver which further increases its real-world usefulness and further separates it from other existing methods. Not only does the simple constraint structure allow for easier application of inspection constraints, but it allows for the application of environmental constraints such as ambient lighting, and for a range of additional sensors to be incorporated into the inspection process. This could mean the integration of directed light sources, RGB/Mono/NIR/IR cameras, laser scanners, and more. Integration into the solver would require a set of deployment constraints informed by each sensor's specific properties to be created and added to the list of inspection space constraints. The nature of the deployment solution formulation also allows for large amounts of flexibility. One consideration is the minimum sensor deployment, but other considerations can include configurations with redundant sensors in case of equipment failures or deployments with multiple sensor types. All of these deployment considerations rely on the synthesis of the inspection spaces.

The solver can also be extended to mobile sensors, such as cameras mounted on robotic manipulators. Not only can the resulting solutions inform the optimal positions for photos to be taken for a full inspection, but they can also inform the trajectory taken between those inspection positions such that it would only move through valid inspection spaces. This would ensure any additional data gathered by the sensor would also be usable data. The trajectory planning aspect itself has further uses as well for problems other than part inspection. By formulating a set of poses for which a given tool can accomplish its task, one can generate a full set of redundant poses that satisfy the given task. By ensuring that the tool remains inside this pose set throughout its task trajectory, an operator can guarantee that the given trajectory would accomplish the task within acceptable quality metrics.

The disclosed solver allows for the generation of solutions to the optimal camera deployment problem which are certifiably valid, repeatable, and optimal. It also addresses the shortcomings of existing art which have prevented existing methods from being implemented in real-world scenarios. Finally, it allows for a series of powerful extensions with the potential to truly revolutionize industrial inspection.

This solver, for example, can be utilized by: Project planners/researchers/engineers—to determine inspection feasibility, inspection quality of existing projects, and to evaluate sensor specifications, sensor quantities, and sensor deployment locations for new projects; Sensor integrators—to aid with simplifying installation requirements by providing flexibility in deployment constraints; Automation researchers/engineers—to determine inspection paths for automated mobile sensor systems (e.g., robotic inspections); and/or CAD/simulation software users—to provide advanced tools for determining object visibilities, evaluate the field of view considering deployment variations, and recommend, visualize and refine sensor deployment solutions.

### Third Example Embodiment

A third example implementation of camera deployment solver module 124 will now be described. In this third embodiment, the inspection task and inspection space are defined for a single “facet of interest”, or foi that is a single facet of the part's triangular mesh model that the camera must inspect, and for which inspection poses will be defined according to inspection constraints.

### Camera Model

As described above in respect of FIG. 3, inputs to the camera deployment solver module 124 includes a camera description (also referred to as a camera model). Establishing the camera model is done to understand how the camera will capture an image and how this will inform the constraints that define whether or not an object is suitably inspected from a given pose. In the present example embodiment, the camera model is assumed to be a thin lens approximation model, which can provide a realistic representation to use as a basis for the deployment of real cameras. This model assumes an aperture with a finite diameter, along with an infinitesimally thin ideal lens. The first basic aspect of the model that must be defined is the optical axis. The optical axis is the presumed axis that passes through the center of the lens and the image center. Next, the principal plane of the camera model is defined as the plane normal to the camera axis which intersects it at the lens. The final basic aspect of the model is the focal point, which can be defined as the point along the optical axis which has the property of any rays passing through it into the lens will be refracted parallel to the optical axis after passing through the lens. The distance between the camera's principal plane and the focal point is referred to as the focal length, f. The focal point is defined as the point behind the lens at which all rays passing through the lens parallel to the optical axis converge. This, coupled with the distance between an object and the lens, I, and the distance from the lens I to the image plane, I′, form the basis for the basic equation describing image formation, as presented in Equation (1).

$$\frac{1}{l} + \frac{1}{{l}^{′}} = \frac{1}{f} \qquad ( 1 )$$

This can be rearranged to represent the distance at which the projection of a given object will converge behind the lens as presented in Equation (2):

$${l}^{′} = \frac{fl}{l - f} . \qquad ( 2 )$$

The next key parameter in the model that is derived from lens characteristics is fₛₜₒₚ, which is the ratio of focal length to aperture diameter, a_{diam}, expressed as in Equation (3):

$${f}_{stop} = \frac{f}{{a}_{diam}} . \qquad ( 3 )$$

The aperture diameter is the diameter of the circular opening at the front of the lens assembly which controls the amount of light let through the lens. Expanding on Equation (2), one can determine the relationship between the locations of the focal plane and the image plane (the focal plane is the plane in front of the lens in which an object will be projected perfectly onto the image plane behind the lens, see Equation (2)) to be as presented in Equation (4):

$${d}_{focus}^{′} = \frac{{fd}_{focus}}{{d}_{focus} - f} . \qquad ( 4 )$$

The final sensor model concept that will be used in constraint generation is the blur circle, or circle of confusion. This phenomenon is the circular blurring that can be seen in an image around an object when it is not perfectly in focus. The blur circle is the result of the projection of the object in question being either in front of or behind the image plane, which results in it being projected as a circle as opposed to a point. The diameter of the blur circle is expressed as presented in Equation (5):

$${c}_{diam} = {a}_{diam} \frac{{l}^{′} - {d}_{focus}^{′}}{{l}^{′}} . \qquad ( 5 )$$

Blur can also be expressed as the blur angle (denoted as θ_{blur}), which is expressed in Equation (6):

$$tan \frac{{θ}_{blur}}{2} = \frac{{c}_{diam} / 2}{{d}_{focus}^{′}} . \qquad ( 6 )$$

By leveraging the small angle identity tan (θ_{blur}/2)≈θ_{blur}/2 and substituting Equation (6) into Equation (5), along with some rearranging, blur angle blur can then be expressed as in equation (7):

$${θ}_{blur} = {a}_{diam} ( \frac{1}{{d}_{focus}^{′}} - \frac{1}{{l}^{′}} ) . \qquad ( 7 )$$

These blur quantities are useful, as they will allow the formulation of upper and lower limits on the distance a given object can be from the focal plane while also remaining sufficiently in focus in the final image to allow for adequate inspection.

The projection of points in front of the camera onto the camera's image plane is also considered. The image plane is the available surface of the camera's sensor and is bound in pixel space by the sensor's height h and width w. Also considered are the pixel aspect ratio δ, sensor skew s, and camera focal length f. Altogether, these can be used to define a camera intrinsic matrix K as shown in Equation (8):

$$κ = ( \begin{matrix}f & s & {c}_{x} \\ 0 & δ f & {c}_{𝓎} \\ 0 & 0 & 1\end{matrix} ) . \qquad ( 8 )$$

In K, (cx, cy) is the ordered pair defining the image projection centre in pixel space. With an ideal lens, this would mean (cx, cy)=(w/2, h/2), but with real lens aberrations, these values may be slightly different from their ideal values, and these offsets are usually derived via camera calibration algorithms. Additionally, the aspect ratio δ is simply the ratio of pixel height to pixel width, and the sensor skew s describes the degree of misalignment of the camera sensor and image plane. Thus, a point o_{w} in world space

$${o}_{W} = ( \begin{matrix}x \\ 𝓎 \\ 𝓏\end{matrix} ) \qquad ( 9 )$$

will be projected into the camera's pixel space on the image plane as:

$$( \begin{matrix}{o}_{C} \\ 1\end{matrix} ) = K ( R \vert T ) ( \begin{matrix}{o}_{W} \\ 1\end{matrix} ) \qquad ( 10 )$$

where (RIT) is the homogeneous transformation matrix defining the point relative to the world and camera frames.

### Set-Based Methods

As described above, in example embodiments the camera deployment solver module 124 applies a constraint evaluation process 125 that applies interval analysis to solve constrain problems. In this regard, the following paragraphs describe aspects of interval analysis and set-based pose representations that can be used to solve constraint problems.

Interval analysis methods find extensions to standard point number mathematical operations using interval values instead of discrete exact values. By treating numbers as intervals, one can account for rounding and measurement errors in calculations and produce ranges of solutions that are guaranteed to contain the true solution to the given problem. Intervals in are represented as:

$$[ x ] = [ \underline{x} , \overline{x} ] = \{ x ∈ ℝ \vert \underline{x} \leq x \leq \overline{x} \} \qquad ( 11 )$$

where x and x̅ are the lower and upper bounds of the interval, respectively.

Other useful components of intervals are their midpoint,

$$m i d ( [ x ] ) = ( \overline{x} + \underline{x} ) / 2 \qquad ( 12 )$$

and their width,

$$w i d ( [ x ] ) = \overline{x} - \underline{x} . \qquad ( 13 )$$

It is also useful to characterize the interactions between multiple intervals. The two key operations for doing so are the intersection of two intervals,

$$[ x ] ⋂ [ 𝓎 ] = [ max ( \underline{x} , \underline{𝓎} ) , min ( \overline{x} , \overline{𝓎} ) ] \qquad ( 14 )$$

and the hull, or interval union, of two intervals,

$$[ x ] ⋃ [ 𝓎 ] = [ min ( \underline{x} , \underline{𝓎} ) , max ( \overline{x} , \overline{𝓎} ) ] . \qquad ( 15 )$$

Interval extensions of functions typically require that the function be monotone, although there are interval extensions of non-monotonic functions. The fundamental theory of interval analysis states that “the interval extension of a monotonic function ƒ([x]) yields the inclusion function [ƒ], such that ƒ([x]) is contained inside of [ƒ],

$$f ( [ x ] ) = \{ f ( x ) \vert x ∈ [ x ] \} ⊆ [ f ] . \qquad ( 16 )$$

These interval methods can also be extended in order to describe vectors and matrices of intervals. An interval vector represents an ordered n-tuple of intervals:

$$[ x ] = [ [ {x}_{1} ] , [ {x}_{2} ] , … , [ {x}_{n} ] ] = [ [ \underline{{x}_{1}} , \overline{{x}_{1}} ] , [ \underline{{x}_{2}} , \overline{{x}_{2}} ] , … , [ \underline{{x}_{n}} , \overline{{x}_{n}} ] ] . \qquad ( 17 )$$

By extension, an interval matrix is represented as:

$$[ A ] = ( \begin{matrix}[ \underline{{a}_{11}} , \overline{{a}_{11}} ] & [ \underline{{a}_{12}} , \overline{{a}_{12}} ] \\ [ \underline{{a}_{21}} , \overline{{a}_{21}} ] & [ \underline{{a}_{22}} , \overline{{a}_{22}} ]\end{matrix} ) . \qquad ( 18 )$$

These interval methods are applied to the inspection constraints in order to allow for a continuous evaluation of the space around a given facet in order to certifiably synthesize its entire valid inspection space.

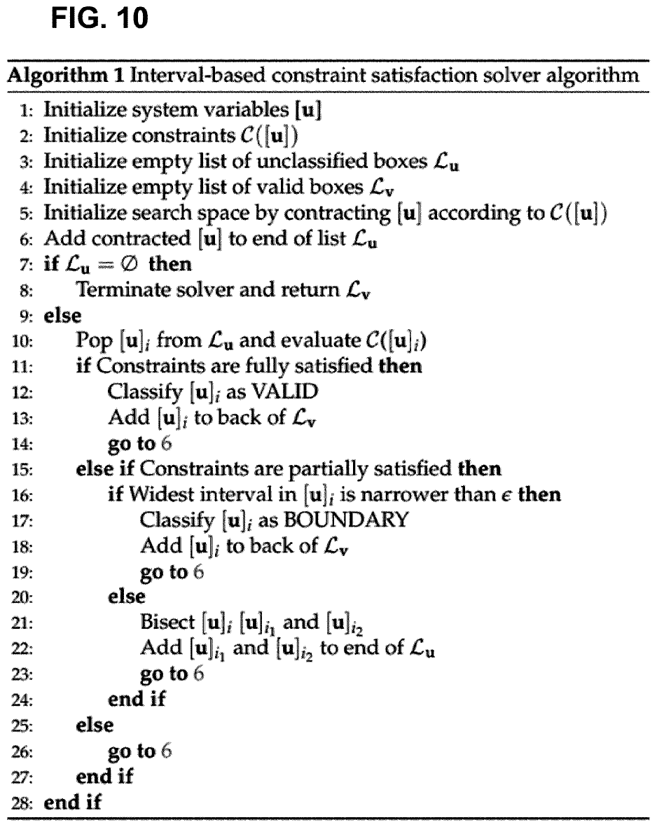

As noted above, interval analysis methods for constraint satisfaction as applied by constraint evaluation process 125 is based on two principal method classes: simplification, and bisection. Given a system of constraints [symbol] ([u]), where [u] represents the constraint variables, the two methods are applied consecutively through an iterative branch and bound process. An example of an interval-based constraint satisfaction solver algorithm that can be applied by constraint evaluation process 125 is shown in Algorithm 1 of FIG. 10.

In example embodiments, simplification methods can be applied that are heuristic methods whose goal is to reduce any excess width of [u] in [symbol] ([u]), such as, for example, HC4, ACID, 2B and 3B filtering, and Newton methods. In some examples, HC4 and ACID heuristic simplification methods are applied in order to simplify initial variable search spaces (represented by interval vectors) according to constraints as much as possible prior to the application of bisection methods to further refine the solutions. These methods work by iteratively applying interval arithmetic to the constraint functions in order to narrow the domains of the variables as much as possible. For instance, HC4 works by applying consecutive iterations of forward arithmetic and backward arithmetic [33], [34] to a tree representation of a system to successively narrow the domain of its variables. For example, in the equation ([x]−[y])²−[z]=0, with [x]∈[0, 10], [y]∈[0, 4], and [z]∈[9, 16]), the forward step yields a result of [−16, 91] at the root. Setting the root to [0, 0] for the backwards step and refining for [x], [x] is simplified to [x]∈[0, 8]. Application of these steps continues over each variable until a given stopping criteria (usually variable width ∈) is met.

Bisection methods split the interval [u] along the dimension i into [u1] and [u2], as long as the width of [u] is greater than a given threshold ∈. The union of these sub-intervals is equal to the original interval and, as such, they still represent a continuous evaluation of the solution space. The bisection strategy used in at least some examples is known as largest-first, in which an interval vector [u] is bisected at the midpoint of its widest component interval, and all other components of the interval vector remain unchained in the resultant child interval vectors. These bisections continue until the widths of all components of [u] are below a given threshold, or [u] is found to either fully satisfy constraints or not represent a valid solution. Bisected intervals are added to the list Lu.

### Set-Based Extensions of Pose and Inspection Constraints

A camera position and orientation are described using x, y, z coordinates and ZXZ Euler angles (φ, γ, β), respectively. Together the position and orientation define the camera pose. The goal of the set-based constraint formulation is to derive the sets of camera poses such that all points on a given facet are visible from the camera, and the camera specification and other inspection constraints are satisfied. That is, the set of poses [symbol] that ensure the facet can be properly inspected is given by:

$$𝒫 = \{ ( x , 𝓎 , 𝓏 , φ , γ , β ) \vert {𝒞}_{k} ( x , 𝓎 , 𝓏 , φ , γ , β ) is valid , x , 𝓎 , 𝓏 ∈ ℝ , φ , γ , β ∈ [ - 2 π , 2 π ] , k = 1 . . n \} \qquad ( 19 )$$

where [symbol] ₖ (x, y, z φ, γ, β) is one of n inspection constraints.

A camera pose interval can be given by [p]=([x], [y], [z], [φ], [γ], [β]ᵢ) for a given facet. The pose solution guarantees that the entire facet satisfies the considered constraints ∀p∈[p], [p]∈

[symbol]

The two elements of pose which must be addressed are position and orientation. The position of a point in the world frame o_{w}, and the set-based extension of this vector, are based on imposing upper and lower uncertainty limits on each element of the vector such that each is transformed to be:

$$[ x ] = [ \underline{x} , \overline{x} ] \qquad ( 20 )$$

$$[ 𝓎 ] = [ \underline{𝓎} , \overline{𝓎} ] \qquad ( 21 )$$

$$[ 𝓏 ] = [ \underline{𝓏} , \overline{𝓏} ] . \qquad ( 22 )$$

Thus, o_{W} becomes [o_{W}], where:

$$[ {o}_{W} ] = ( \begin{matrix}[ x ] \\ [ 𝓎 ] \\ [ 𝓏 ]\end{matrix} ) \qquad ( 23 )$$

where [o_{W}] now represents all of the points contained inside a 3D box in position space, as opposed to the discrete point represented by o_{W}.

Orientation is represented in example embodiments as a vector of ZXZ Euler angles (φ, γ, β) as:

$$e = ( \begin{matrix}φ \\ γ \\ β\end{matrix} ) \qquad ( 24 )$$

This representation is chosen due to its ease of bisection, and its compatibility with orientation constraints. These rotations are applied successively such that the rotation matrix of cumulative rotation operation can be expressed as:

$${R}_{e} = {R}_{𝓏} ( φ ) {R}_{{x}^{′}} ( γ ) {R}_{{𝓏}^{″}} ( β ) \qquad ( 25 )$$

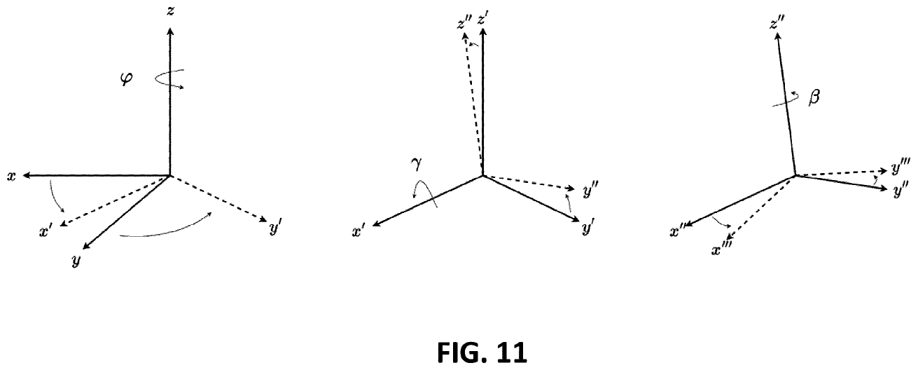

and is demonstrated in FIG. 11.

This ZXZ representation can easily be extended to a set-based context using intervals much like the position was in Equation (23) such that e becomes [e]:

$$[ e ] = ( \begin{matrix}[ φ ] \\ [ γ ] \\ [ β ]\end{matrix} ) = ( \begin{matrix}[ \underline{φ} , \overline{φ} ] \\ [ \underline{γ} , \overline{γ} ] \\ [ \underline{β} , \overline{β} ]\end{matrix} ) . \qquad ( 26 )$$

Thus, [e] now represents a 3D box in rotation space as opposed to the single finite point represented by e. Together, [o_{W}] and [e] represent a 6D box (e.g., a pose interval) in pose space that describes a continuous set of poses.

The position and orientation intervals are solved as two separate constraint systems in this example, along with a third constraint system for determining if any derived poses result in the camera's view of the foi being occluded by any objects within the scene. Since the occlusion test is orientation-independent, it is grouped with position constraints but is solved by a separate system of constraints within the position constraints.

### Position Constraints

The position constraints that must be solved for a given pose box [p] in the main position constraint system [symbol] for a facet are: 1. Does [p] intersect the facet?; 2. Is [p] an appropriate distance from the facet?; 3. Is [p] in front of the facet?; and 4. Does [p] inspect the facet from a suitable angle?First, to test if [p]intersects the facet, we consider the set of all points on the surface of the facet as the region bounded by the set of plane inequality constraints. [symbol] . [symbol] is defined by the 3D plane that contains the facet, and the three planes perpendicular to it, which each contain one of the edges of the facet. We can then say:

$$\begin{matrix}{C}_{f} ⋂ [ p ] \neq ∅ , & [ p ] is not valid\end{matrix} \qquad ( 27 )$$

$$\begin{matrix}{C}_{f} ⋂ [ p ] = ∅ , & [ p ] satisfies constraint 1 , continue .\end{matrix} \qquad ( 28 )$$

To solve for the valid set of [x], [y], [z] positions in [p] for the facet bounded by [symbol] , the following distance constraint is applied:

$${C}_{distance} = {( \begin{matrix}[ x ] \\ [ y ] \\ [ z ]\end{matrix} )}^{2} - {[ c ]}_{f}^{2} ⊆ [ {d}_{min}^{2} , {d}_{max}^{2} ] \qquad ( 29 )$$

where dmin and dmax are constants defining the minimum and maximum depth of field values for the image of the facet to be suitably in focus for a given inspection camera, and [c]_{ƒ} is the interval vector containing the valid solutions to [symbol] . The dmin and dmax parameters are derived according to lens intrinsic parameters. They determine how far away from the facet a camera can be while still satisfying inspection requirements. The constraint for testing whether a box [p] is in front of a facet is called the backface constraint, and is evaluated by creating a half-space constraint defined by the plane containing the facet. Using the facet's normal, n=[nₓ, n_{y}, n_{z}]^{T}, and one vertex, v=[νₓ, ν_{y}, ν_{z}]^{T}, we can define the constraint as:

$$[ p ] = \{ \begin{matrix}in front : & if ( [ p ] - v ) \cdot n > 0 \\ intersecting : & if 0 ∈ ( [ p ] - v ) \cdot n \\ behind : & if ( [ p ] - v ) \cdot n < 0.\end{matrix} \qquad ( 30 )$$

Finally, to determine if the viewing angle is sufficiently large for the foi to be inspectable, we define the constant θ_{ν} as the minimum viewing angle, and the facet's geometric center as f_{jc}. The constraint is then:

$$arccos ( ( {[ p ]}_{i} - {f}_{{j}_{c}} ) ) \cdot n \leq ( \frac{π}{2} - {θ}_{v} ) . \qquad ( 31 )$$

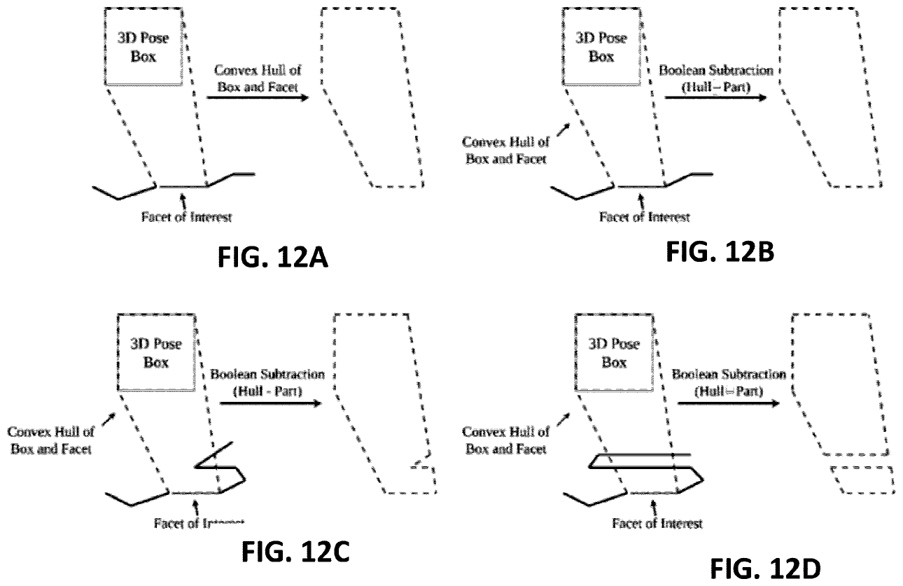

Once box [p] has been shown to satisfy these position constraints, it must be tested to ensure that no position in it represents one whose view off would be occluded by any other geometry within the scene (either internal, i.e., other facets belonging to the part, or external, i.e., by other objects/geometries present in the inspection space). In the present example, only the [x], [y], [z] components of [p] are considered in this test, as it is primarily concerned with determining if there is any straight continuous path between any point on the facet and any point in the position box which intersects other geometries. The occlusion testing process will be demonstrated herein in 2D, but the techniques in question are easily extrapolated into 3D. The first step in the occlusion testing algorithm is to build the convex hull containing both [p] and the facet of interest (this will be called the camera mesh) as shown in FIG. 12A. This convex hull is constructed, and further operations are conducted, using exact predicates and geometric operations with CGAL such that it can be certified that any results are an exact computation of any further mesh boolean operations.

The scene mesh is then subtracted from this camera mesh, and the visibility of the facet of interest from [p] can then be quantified based on the result of this boolean difference operation. The first test case will be for a set of camera positions for which the facet will be fully visible. FIG. 12B shows the camera mesh and the part mesh before the differencing operation, as well as the resultant mesh. As the box represents positions from which the facet is fully visible, the camera mesh remains unchanged, as one would expect.

Next, a box in which some, but not all, positions within the set have another geometry occluding the facet is presented. FIG. 12C shows the camera mesh and the part mesh, along with the resultant mesh, before and after the differencing operation.

From these, it is plain to see the effect that the differencing operation has had on the camera mesh, as the section of the part mesh that intersected the camera mesh has been subtracted from the initial camera mesh. The resultant void causes the differenced mesh to have more facets than the original camera mesh, which tells the algorithm that at least some degree of occlusion is present. One can say that the occlusion is partial rather than full, because while the differenced mesh is discontinuous, the vertices corresponding to the camera position box and those corresponding to the facet of interest are still part of the same continuous sub-mesh, and there are still edges remaining which connect at least one box vertex to at least one facet vertex.

Finally, a box for whom all inner positions represent an occluded view is presented. FIG. 4B shows the camera mesh, the part mesh, and the resultant mesh. Because the mesh subtracting has resulted in two separate meshes, which separately contain the original box vertices and the original facet vertices, the algorithm will classify this result as a case in which the particular facet of interest is fully occluded from any viewpoint within the original pose box. While this is the most common case for a full occlusion, there is a second case to consider: the case in which the subtraction still results in one continuous mesh, but one which does not contain any of the original facet vertices. This would be the case for a box that was behind the plane of the facet of interest, which, while possible, would be filtered out as a possible valid set of poses by the previously described backface culling condition.

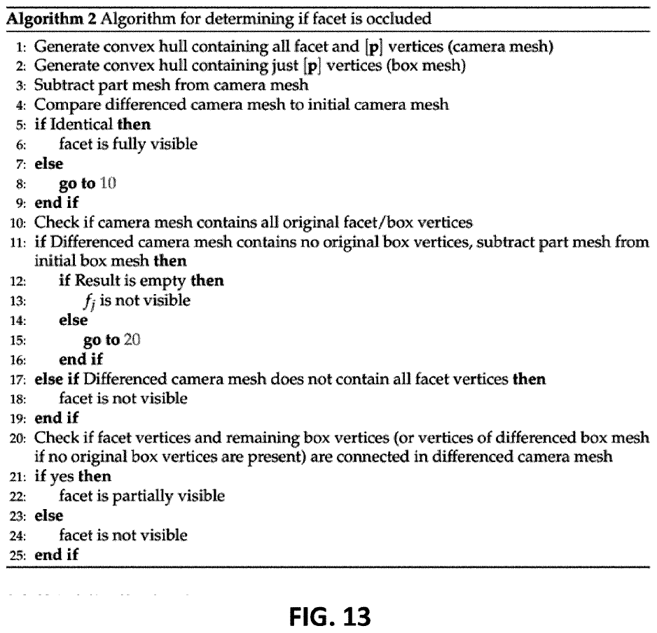

A process for classifying the visibility of the facet of interest from [p] using the above methods is described in Algorithm 2, shown in FIG. 13.

### Orientation Constraints

The orientation of the camera from any given position such that the facet is within its field of view is primarily determined by the camera's field of view (FOV) half angles. Let the FOV half angles be α_{ν} and αₕ for the vertical and horizontal axes, respectively. The camera axis c is given by:

$$[ c ] = [ R ( [ φ ] , [ γ ] , [ β ] ) \text{:} \hat{z} \qquad ( 33 )$$

$$where$$

$$\hat{z} = ( \begin{matrix}0 \\ 0 \\ 1\end{matrix} ) . \qquad ( 34 )$$

A FOV constraint C_{FOV}(x, y, z, φ, γ, β) is formulated to ensure that the entire facet is visible from the camera pose. Before constraint systems can be generated and solved to define complete orientation intervals, a few transformations must be made in order to simplify the problem and allow for a more efficient solving. The formulation of the orientation limits for a given box corresponding to a given facet begins by considering the facet vertices and the 3D box defining a set of solutions for camera position. The facet vertices are presented in a matrix of discrete values, F_{ν}, as:

$${F}_{v} = ( \begin{matrix}{v}_{{1}_{x}} & {v}_{{2}_{x}} & {v}_{{3}_{x}} \\ {v}_{{1}_{y}} & {v}_{{2}_{y}} & {v}_{{3}_{y}} \\ {v}_{{1}_{z}} & {v}_{{2}_{z}} & {v}_{{3}_{z}}\end{matrix} ) . \qquad ( 35 )$$

Solving also requires the camera position box, [p], and facet bounding box [o]_{ƒ}. The difference equations in Equations (36) and (37) are then applied in order to transform the facet and vertex boxes such that instead of attempting to determine the relationship between two boxes, we can examine the positions of the boxes relative to a common discrete origin. The difference of the facet and camera boxes is referred to as [d]_{ƒ} and that of the vertices and the camera is [D]_{ν}.

$${[ d ]}_{f} = {[ o ]}_{f} - [ p ] \qquad ( 36 )$$

$${[ D ]}_{v} = {F}_{v} - ( [ p ] , [ {p}^{′} , [ {p}^{′} ) \qquad ( 37 )$$

By then taking the midpoint of [d]_{ƒ}, one can solve for a nominal camera vector cnom originating at the centre of [p]ᵢ and passing through the facet geometric centre. If we consider this as the z-axis of a nominal camera frame, we can use simple transformations to solve for the first two components of a ZXZ Euler angle rotation sequence, which results in a nominal camera frame oriented towards the facet from [p]. We call these values φₙₒₘ and γₙₒₘ, and we set βₙₒₘ=0. Finally, we apply the ZXZ Euler rotation sequence defined by R(φₙₒₘ, γₙₒₘ, βₙₒₘ) to the columns of [D]_{ν},

$${[ D ]}_{{v}_{1 : 3 , i}}^{′} = {{R ( {φ}_{nom} , {γ}_{nom} , {β}_{nom} ) [ D ]}_{v}}_{1 : 3.1} , \\ i = 1 …3 \qquad ( 38 )$$

in order to place the vertices of the differenced box into camera space. We call this transformed matrix [D]′_{ν}. From here, we can define two constraint systems which will solve the orientation components. It should be noted that the first constraint system is solving for the allowable offsets of [φ] and [γ] ([φ]_{offset} and [γ]_{offset}) about their nominal values (φₙₒₘ, γnom), and the final [φ] and [γ] intervals will be the sum of the offset intervals and the nominal values. However, the second constraint system solves for [β] directly.
Allowable [φ]_{offset} and [γ]_{offset} Intervals

By considering each rotation component separately and considering the corresponding FOV half angles, a set of four hyperplanes can be created passing through the origin which bound the points in [D]′_{ν} from Equation (38). These four hyperplanes are split into two pairs, with one pair parallel to the camera frame's XZ-plane, and the other parallel to the camera frame's YZ-plane. By rotating each in opposite directions about the camera's X- or Y-axis, respectively, we create an artificial “frustum” which bounds the vertices of [D]′_{ν}. By examining the angles between each hyperplane and its original plane in the camera frame, we can determine the allowable offsets about φₙₒₘ and γₙₒₘ. The variables involved in this constraint system are the four hyperplane angles,

$$1. [ {φ}_{left} ] ∈ [ 0 , π ]$$

$$2. [ {φ}_{right} ] ∈ [ - π , 0 ]$$

$$3. [ {γ}_{up} ] ∈ [ - π , 0 ]$$

$$4. [ {γ}_{down} ] ∈ [ 0 , pi ]$$

along with the constants:

$$1. {α}_{h}$$

$$2. {α}_{v}$$

$${3. [ D ]}_{v} .$$

This, in turn, leads to the constraints:

$${[ D ]}_{{v}_{1 x}} cos [ {φ}_{left} ] + {[ D ]}_{{v}_{1 z}} sin [ {φ}_{left} ] \leq 0 \qquad ( 39 )$$

$${[ D ]}_{{v}_{1 x}} cos [ {φ}_{right} ] + {[ D ]}_{{v}_{1 z}} sin [ {φ}_{right} ] \geq 0 \qquad ( 40 )$$

$${[ D ]}_{{v}_{1 y}} cos [ {γ}_{up} ] + {[ D ]}_{{v}_{1 z}} sin [ {γ}_{up} ] \leq 0 \qquad ( 41 )$$

$${[ D ]}_{{v}_{1 y}} cos [ {γ}_{down} ] + {[ D ]}_{{v}_{1 z}} sin [ {γ}_{down} ] \geq 0 \qquad ( 42 )$$

$$[ {φ}_{right} ] - [ {φ}_{left} ] \vert \leq {α}_{h} . \qquad ( 43 )$$

$$\vert [ {γ}_{up} ] - [ {γ}_{down} ] \leq {α}_{v} . \qquad ( 44 )$$

By then using HC4 and ACID contractors to contract the interval variables, we can solve for their domains,

$${[ φ ]}_{offset} = [ - {α}_{h} + \underline{{φ}_{left}} , {α}_{h} + \overline{{φ}_{right}} ] \qquad ( 45 )$$

$$and$$

$${[ γ ]}_{offset} = [ - {α}_{v} + \underline{{γ}_{down}} , {α}_{v} + \overline{{γ}_{up}} ] . \qquad ( 46 )$$

Having solved for the domains, we can then define the full allowable φ and γ intervals for the given pose box as:

$$[ φ ] = {φ}_{nom} + {[ φ ]}_{offset} \qquad ( 47 )$$

$$[ γ ] = {γ}_{nom} + {[ γ ]}_{offset} . \qquad ( 48 )$$

### Allowable β Interval

Once allowable [φ] and [γ] intervals have been calculated for a given pose box, it is possible to identify the allowable [β] angle interval for a given set of camera poses. The process starts with [D]′_{ν}. We can then solve for the projection of each of the vertices (the columns of [D]′_{ν}) onto the camera's image plane. For each column [d]′ᵥᵢ, i=1 . . . 3 in [D]′_{ν}, we can use the matrices K and [R([φ], [γ], [β])] to get the projection [d]′ₚᵢ:

$${[ d ]}_{{p}_{i}} = K [ {R ( [ φ ] , [ γ ] , [ β ] ) [ d ]}_{{v}_{i}}^{′} , \\ i = 1 …3 . \qquad ( 49 )$$

Because K and [d]′_{νi} are constant matrices, and we have already solved for [φ] and [γ], we can then define the constraints:

$$K [ R ] {{( [ φ ] , [ γ ] , [ β ] ) [ d ]}_{v}^{′}}_{i} > {( 0 )}_{3 \times 1} \qquad ( 50 )$$

$${K [ R ] {{( [ φ ] , [ γ ] , [ β ] ) [ d ]}_{v}^{′}}_{i} )}_{1 : 2} < ( \begin{matrix}w \\ h\end{matrix} ) . \qquad ( 51 )$$

then subsequently apply a combination of HC4 and ACID contractors to contract the domain of [β], such that the constraints are satisfied.

### Overall Pose Solver Algorithm

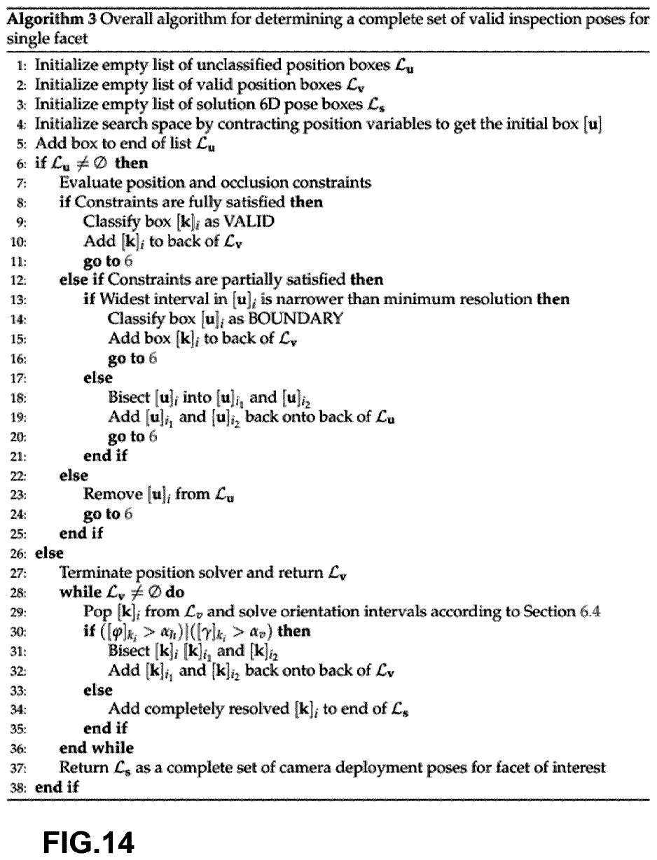

Using all of the concepts described above in respect of the third embodiment, it is now possible to formulate an overall pose solver algorithm for a single facet in an arbitrary 3D mesh representing a real part geometry. First, the initial constraints are formulated for determining whether or not a given set of poses represents a valid solution to the inspection pose problem. This includes distance constraints, orientation/field of view constraints, and visibility and occlusion constraints. Next, using interval-based system contraction methods, the search space around the part is contracted to find the initial position search space, which is the axis-aligned bounding box that most tightly bounds all possible solutions. From there, the position constraints are evaluated over this box, and it is iteratively subdivided and analyzed in order to determine the full set of valid, boundary, and invalid position boxes within the initial box. Next, the boxes are tested for any possible occlusion of a camera's view of the facet from that box by any other geometries present in the scene. Finally, these position boxes have their respective orientation intervals evaluated as per the method in Section 6.4, and are subsequently refined/subdivided should they be too wide for the camera's field of view. Once all pose intervals (position and orientation) for each box have been solved and all boxes have been classified, the full tree structure containing all boxes is returned as the final synthesized solution set of all possible valid inspection poses for the facet of interest. This process is detailed in Algorithm 3 of FIG. 14.

### Fourth Example Embodiment

A fourth example implementation of camera deployment solver module 124 will now be described. In the above-described third embodiment, the inspection task and inspection space were defined for a single “facet of interest”. This fourth example embodiment expands on the concepts of the third example embodiment to solve inspection task and inspection space for multiple facets of interests.

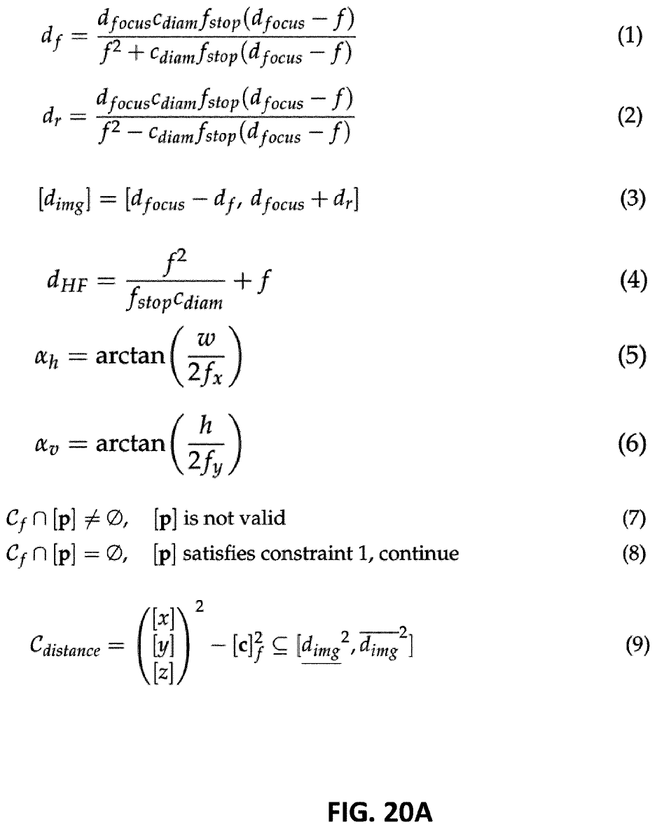

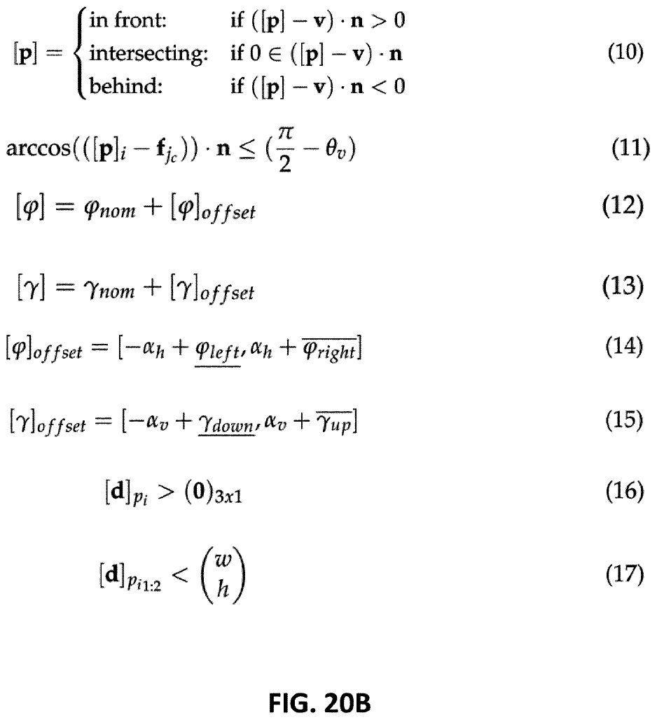

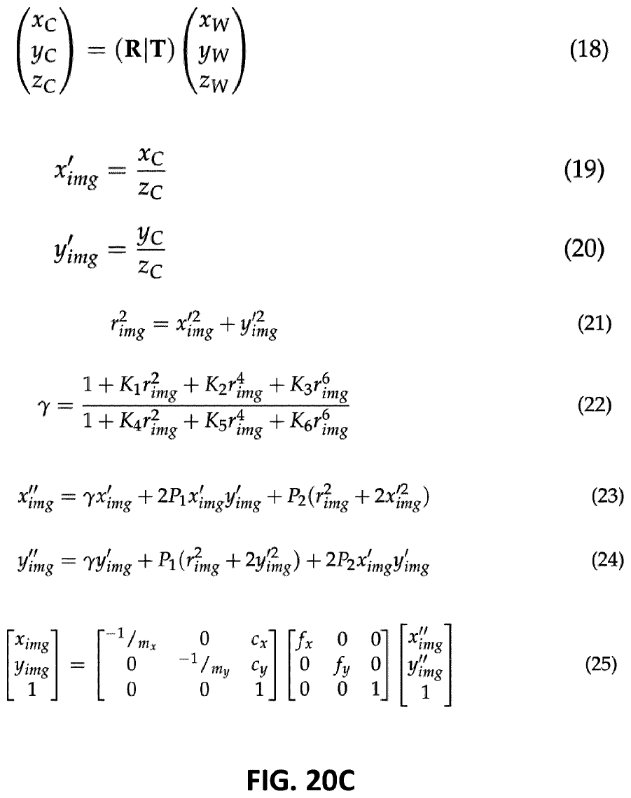

For the description of this third embodiment, the numbering of equations is restarted at (1) and all equations identified below are shown in FIGS. 20A through 20C.

The problem this fourth example implementation addresses is that of synthesizing a complete and certifiable set of possible inspection poses for the machine vision-based quality inspection of a manufactured part represented as a tessellated 3D mesh. A fundamental process for solving camera deployment solutions involves the 6D search space about the part being iteratively subdivided according to interval analysis based branch and bound algorithms, with each subdivision being tested to see if it satisfies the requisite constraints to be considered a valid pose solution for a given facet or set of facets. Constraints can be considered as either task constraints or imaging constraints. These are differentiated by whether the constraint parameters are informed by elements of the task (e.g., including the environment) itself, or are dependent on sensor extrinsic and intrinsic parameters.

The key task constraints considered are: 1. Is the set of facets in front of the camera from a given set of poses?; 2. Is the camera an appropriate distance from the set of facets; 3. Are the facets occluded by any other geometry?; and 4. Is the camera oriented such that all facets are within its field of view (FOV)?

Subsequently, the key imaging constraints considered are: 1. Does the set of viewing angles allow for sufficient imaging resolution?; 2. Are the facets able to be adequately in focus? Are the depth of field (DOF) limits appropriate based on camera parameters?; and 3. Do all facets appear in the captured image, even in the presence of real lens distortions?

The methods described herein in respect of this fourth example embodiment define a modified constraint satisfaction algorithm to allow for the use of multiple facets of interest. It allows for the generation of constraint parameters from real camera models and accounts for real camera extrinsic/intrinsic parameters along with the inherent uncertainty in each. It also proposes a basic multi-camera deployment recommendation process in order to use the generated pose solution sets to generate realizable camera deployment networks.

### Modified Constraint Satisfaction Algorithm

The multi-facet solution synthesis case requires solving for a complete set of camera deployment solutions of every facet of interest in the space around the part, as opposed to one, requiring modification of the standard branch and bound methods applied in the single facet case of the third example embodiment described above. This is because the multi-facet case is essentially solving several constraint satisfaction problems simultaneously, as opposed to the single problem in the single-facet case. The multi-facet reformulation starts with a definition of a box (e.g., pose interval). In the single facet case, each box would be defined as an object whose attributes are a 6D interval vector describing its full set of valid poses, a classification as either valid for the facet of interest, partially valid for the facet of interest, or invalid for the facet of interest, and a unique ID number along with the ID numbers of both its parent and child boxes (when a box is subdivided via bisection, the two resulting boxes are considered the children of the original parent box).

The multi-facet case uses this as a starting point but adapts it and adds several new features that allow for a more efficient evaluation of the search space with multiple facets of interest. Boxes are organized in a hierarchical tree structure populated during bisection operations, and are defined as objects with the following parameters:
1. 6D pose interval vector
2. List of valid facets
3. List of boundary facets
4. Unique ID key
5. ID key of the parent
6. Boolean value designating if the box is a leaf on the tree
7. Boolean value designating if the box is a boundary box
8. Vector of interval vectors containing orientation angles for all valid facets
9. Vector of interval vectors containing orientation angles for all boundary facets

It should be noted that in this context, a valid facet is considered to be a facet of interest for which a given box satisfies all pose constraints, and a boundary facet is a facet of interest for which a box contains a region that satisfies constraints but for which the entire box does not represent a completely valid solution. Additionally, a leaf on the tree is defined as a box which does not require full subdivision (this will be explored in greater detail in later sections) and a boundary box is one that will not be further subdivided and has no valid facets but some boundary facets. The multi-facet algorithm also shares some similarities in that it retains the structure of first solving the x-y-z position intervals for the full set of boxes and then solving the valid orientation angles for each box, but it adds some additional complexities including constraint generation from real camera intrinsics taking into account realistic camera models, and an additional stage at the end testing for any facets which will be pushed out of the camera's image by lens distortion effects.

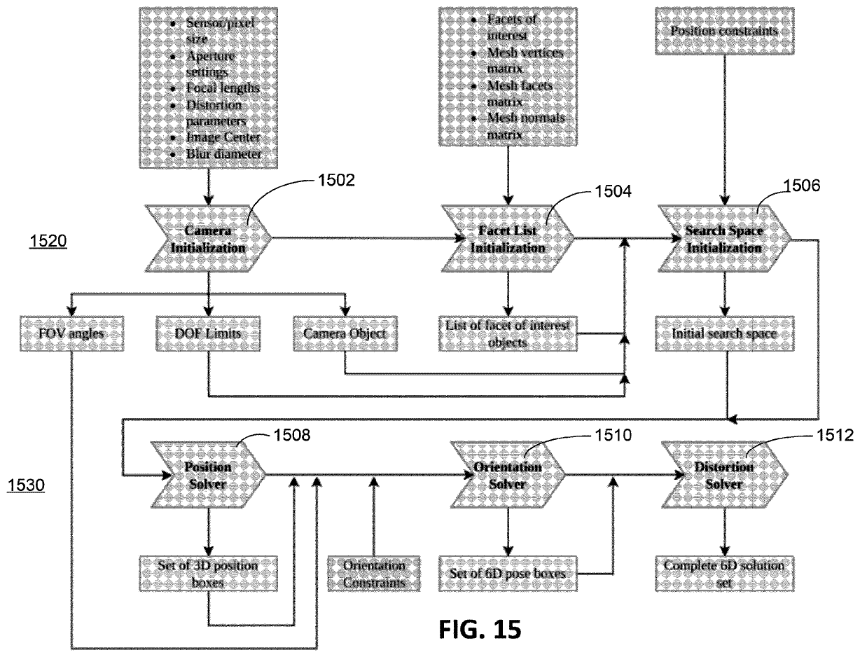

At a high level, the flowchart presented in FIG. 15 illustrates operations performed by a configuration process 1520 and a constraint evaluation process 1530 (also referred to as a solver loop or solver) in a fourth example embodiment.

### Configuration Process

Configuration/Initialization 1520 involves pre-solving and pre-allocating as many solver parameters as possible before entering a main solver loop 1530, and includes camera initialization 1502, facet list initialization 1504 and search space initialization 1506.

### Camera Initialization 1502

At the heart of the pose synthesis process is the camera from which poses will be derived. While detailed descriptions of camera models, parameters, and constraint derivations will be explored in greater detail in later sections, at a higher level, the camera is defined as an object with the following parameters:
1. Field of view angles αₕ and αᵥ
2. Available f-stop (aperture) settings
3. Focal lengths ƒₓ and ƒ_{y} from camera matrix
4. Sensor size and pixel pitch
5. Brown-Conrady lens distortion parameters
6. Image center values
7. Depth of field limits
8. Maximum allowable image blur circle diameter, c_{diam}

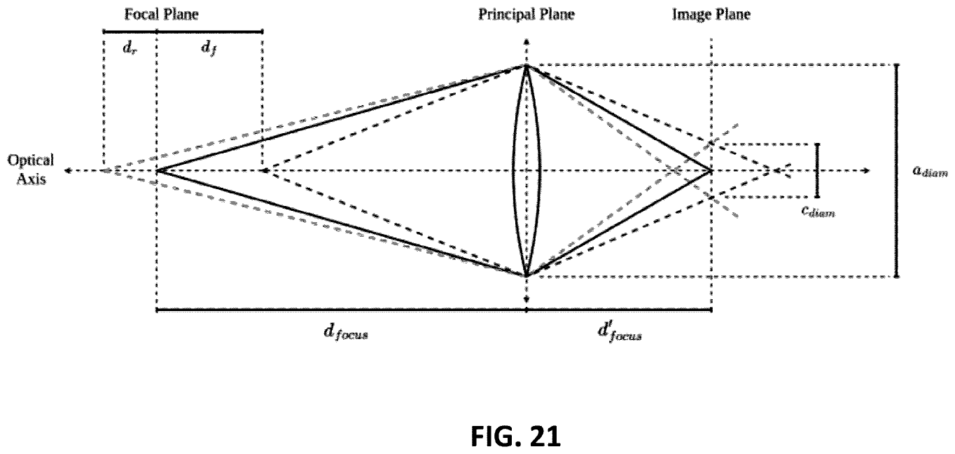

Most of these are specifications available directly from camera datasheets (field of view angles, f-stops, focal length, sensor/pixel dimensions), but others must be solved or derived by the user. For instance, distortion parameters, image center values, and x and y focal lengths are derived by the user during camera calibration (they are usually used for image distortion correction algorithms, but they also inform the derivation of distortion constraints later on), maximum blur circle diameter is specified by the user, and depth of field limits must be solved based on available f-stop values. In order to determine the acceptable distance range for an object to be imaged suitably sharply, the front and rear depth of field limits, d_{ƒ} and dᵣ, must be evaluated. FIG. 21 illustrates the DOF limits and their relationship to C_{diam}.

The DOF limits are calculated according to Equations 1 and 2 shown in FIG. 20A. The full acceptable distance interval for the image, d_{img} is then defined as in Equation 3 in FIG. 20A.

It should be noted that this approach assumes a fixed working distance for a lens, i.e. one that does not have variable focus settings. While this approach is fine in theory, in practice most lenses have variable focus settings and as such it is overly simplistic and must be extended to model a variable focus lens. Fortunately, the extension is not overly complex. The focus setting on a standard variable focus lens is typically referred to as the working distance, d_{focus}. This quantity is the distance at which a point will be perfectly projected onto the image plane with no blur. Most standard focus lenses have working distance settings from some minimum working distance (the smallest distance at which the lens can perfectly project a point onto the image plane), d_{MW}, up to infinity. In practice though, the maximum setting is referred to as the hyperfocal distance, and it represents the distance beyond which any objects will appear equally in focus on the image plane, regardless of their relative positions. The hyperfocal distance, d_{HF}, is defined as shown in Equation 4 in FIG. 20A.

While d_{HF} is a parameter that the user must derive, d_{MW} is defined by the camera/lens 264 manufacturer. In order to then determine the appropriate d_{img} interval for a real variable zoom lens, d_{img} is calculated for d_{focus}=d_{MW} and d_{focus}=d_{HF}. The intersection of these two intervals is then taken and the result is used as the final d_{img} for the definition of minimum and maximum distance constraints in the solver algorithm. This process is used because it allows for certification of the fact that if all features fall within this d_{img} interval there is some zoom setting on the lens which will allow for all features to be imaged with acceptable focus. It is also important to briefly discuss the effect of fₛₜₒₚ values on DOF intervals. The fₛₜₒₚ value defines the relationship between focal length (a fixed quantity) and aperture diameter (a variable quantity). While on most practical lenses the aperture diameter is technically continuously variable, the control for it is typically indexed to a standard set of values such that the amount of light entering through the lens increases/doubles by a factor of 2 at each setting. As such, it is often sufficient to calculate the discrete d_{img} intervals at each standard setting in the lens range as opposed to calculating a continuous set of d_{img} intervals. The aperture setting is typically selected based on the lighting conditions of the working environment, but also by d_{img} limits imposed by working environment geometry, as the fₛₜₒₚ number also affects the available DOF.

In the case where field of view angles are not explicitly included in camera documentation, it is possible to derive them as follows. They are commonly defined as half-angles, referred to as α, where the angle is defined as that between the optical axis and the plane defining the edge of the camera's view frustum. The full angle would then be the angle between the two frustum bounding planes and is equal to 2α.

The horizontal and vertical FOV angles are calculated based on the camera's focal length and corresponding sensor dimensions according to Equation 5 and Equation 6, respectively, as shown in FIG. 20A. In these equations, w and h represent sensor width and height in millimetres. Once the FOV angles have been solved, they are used to derive the allowable orientation intervals for box/facet pairs.

### Facet List Initialization 1504

The facet of interest initialization involves the specification of the facets of interest and then the initialization of several useful parameters. Facets of interest are initially specified by the user as those that require inspection for the given task, and the list of them is typically imported into the solver as a .csv file containing the IDs assigned to the facets of interest in the mesh by the mesh model file. Once the list of facets of interest has been specified, each facet of interest is initialized as an object with the following parameters:
1. Facet ID
2. Vertices in the mesh model
3. Vertex positions
4. Facet normal
5. Facet geometric barycenter
6. List of possible occluding facets

While the facet ID, vertex indices and positions and normal are all geometric quantities that can be found directly from the part mesh model, the possible occluding facets (POFs) are defined as any facets that have at least one vertex located in front of the plane containing the facet of interest.

### Search Space Initialization 1506

In order to begin the solver, an initial box must be declared that tightly bounds the region containing all possible solutions. This process defines a system of position constraints for each facet of interest, and that system is contracted using HC4 and ACID contractors over these constraint systems over these constraints in order to find the region which most tightly bounds all valid solutions for that facet. This is done for each facet of interest, and then the union of all of those boxes is taken to find the region that is certified to contain all valid solutions for all facets of interest. Once the initial box has been solved, it has a unique ID assigned to it and has all facets of interest assigned to its list of boundary facets as potential candidates to be valid facets for future child boxes further along in the solver. It also has its parent ID listed as NULL and all other quantities initialized as empty.

### Constraint Evaluation Process 1530 (Solver Loop)

Once the initial solver parameters have been established, a set of solver processes (position solver 1508, orientation solver 1510, distortion solver 1512) are used to solve for a search space solution.

### Position Solver 1508

Position solver 1508 is given a list of boxes where each has a list of boundary facets of interest, and then for each boundary facet of interest, it evaluates its position constraints over a current test box. If the test box is found to fully satisfy all constraints for a given facet of interest, the occlusion condition is then tested according to the procedure described above in respect of the third example embodiment for the test box/facet of interest pair. If no occlusion exists, the facet of interest is then considered a valid (observable) facet from the given position box and it is removed from the boundary facet list and placed on the valid facet list. If at any point the test box is found to violate the constraints for any of its candidate boundary facets of interest, that facet of interest is removed from the boundary list and any future consideration for child boxes. Consequently, if a box is found to only partially satisfy a facet of interest's constraints, that facet of interest is kept on the boundary facets list to be checked against future children of the current box. Once all position and occlusion constraints have been tested for all candidate facets of interest for the box, the position solver 1508 then checks the box's dimensions and boundary facets list. If the box's largest dimension is above a given threshold and there are still boundary facets on its list, then the box is bisected into two children. The children are given unique identifiers, have the parent's identifier attached to their parent parameter, inherit the parent's valid and boundary facets list, and are pushed to the end of the list of boxes for the algorithm to test. However, if a box is found to have boundary facets remaining but is below the size threshold, it is classified as a boundary box and subjected to no further testing or bisection. If a box has no boundary facets remaining, it can be either classified as a leaf (if the number of valid facets is greater than zero) or an invalid box (does not even partially satisfy constraints for any facet of interest). In either scenario, the box will be removed from any further testing or bisection. This process repeats until all boxes have been eliminated or classified as boundary or leaf boxes.

The key position system constraints [symbol] ₚ for a pose box [p] for a facet are: 1. Does [p] intersect the facet?; 2. Is [p] an appropriate distance from the facet?; 3. Is [p] in front of the facet?; and 4. Does [p] inspect the facet from a suitable angle?

First, to test if [p] intersects the facet, the constraint set out in Equations (7) and (8) of FIG. 20A are considered. To test that the camera is an appropriate distance from the box, the distance constraint set out in equation (9) of FIG. 20A is evaluated, where [c]_{ƒ} is the interval vector containing the valid solutions to [symbol] _{ƒ}.

The constraint for testing whether a box [p] is in front of a facet is called the backface 370 constraint and is defined as shown in Equation (10) in FIG. 20B.

Finally, to determine if the viewing angle is sufficiently large for the facet of interest to be inspectable, the constraint is defined as set out in Equation (10) in FIG. 20B, where the constant θᵥ is the minimum viewing angle, and the facet's geometric center is f_{jc}.

If these constraints have been satisfied for a given box/facet pair, it is tested to determine the presence of any occluding geometry and the degree of any such occlusion. As described above in respect of the third example embodiment, this is done by taking the convex hull of the box and facet and performing a mesh boolean subtraction in which the part geometry (and any additional scene geometry) is subtracted from it. If the result of this operation is equivalent to the initial convex hull, there is no occlusion. If the hull has changed, the occlusion condition is tested by determining if there is a continuous path from any facet vertex to any box vertex along the surface of the resultant hull; if there is, the occlusion is only partial, if not the facet is fully occluded.

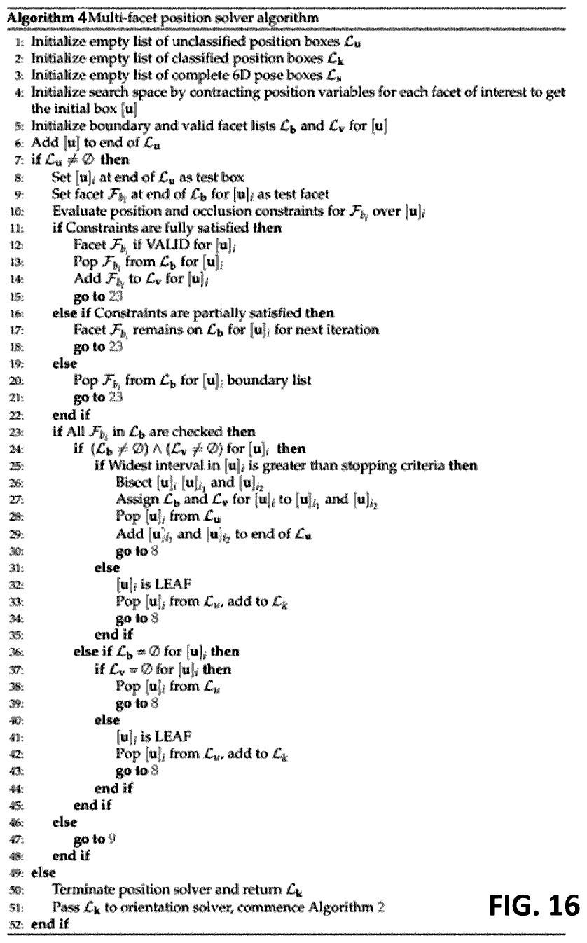

An algorithmic representation of an example of operation of multi-facet position solver 1508 is illustrated as Algorithm 4 in FIG. 16.

### Orientation Solver 1510

Once the full set of position boxes has been synthesized, along with their list of valid facets, their corresponding valid orientation intervals can be solved. It should be noted that each facet of interest has its orientation intervals solved for a given box according to the methods described above in respect of the third example embodiment, but there few additional steps in order to account for the box's intervals having to represent a valid pose for multiple facets. Initially, each facet on a given box's valid and boundary lists has its valid orientation angles solved via the process outlined in above in respect of the third example embodiment and the box's orientation intervals are set as the union of all of those angle intervals. Next, the width of the box's orientation intervals is checked, and if they are wider than the allowable maximum width determined by the camera's FOV angles, the box is bisected along its widest orientation interval. Otherwise, the orientation solver proceeds to check individual facets. It first checks the boundary facet intervals against the box interval, and if they intersect the facet remains classified as a boundary facet, but if not it is eliminated. For the valid facets, the orientation solver checks if their intervals contain the midpoint of the box intervals. If they do, it remains a valid facet. If they do not, but the intervals still both intersect, the facet is pushed to the boundary facet list, and if there is no intersection for one or both intervals it is eliminated altogether.

Orientation Constraints—The orientation interval representation used herein is a ZXZ Euler rotation sequence 407 [R([φ], [γ], [β])] as described above in respect of the third example embodiment [12]. The first two components, [φ] and [γ] are defined as shown in Equations (12) and (13) of FIG. 20B, where φₙₒₘ and γₙₒₘ are the angles corresponding to a rotation which orients the camera such that if it is located at the midpoint of the box, its axis will pass through the barycenter of the facet. Additionally, [φ]_{offset} and [γ]_{offset} are defined as in Equations (14) and (15) of FIG. 20B, where φ_{left}, φ_{right}, γ_{down}, and γᵤₚ are how much the camera axis can rotate in any one direction while still keeping the facet entirely within its field of view for any position in ([x], [y], [z])^{T}.

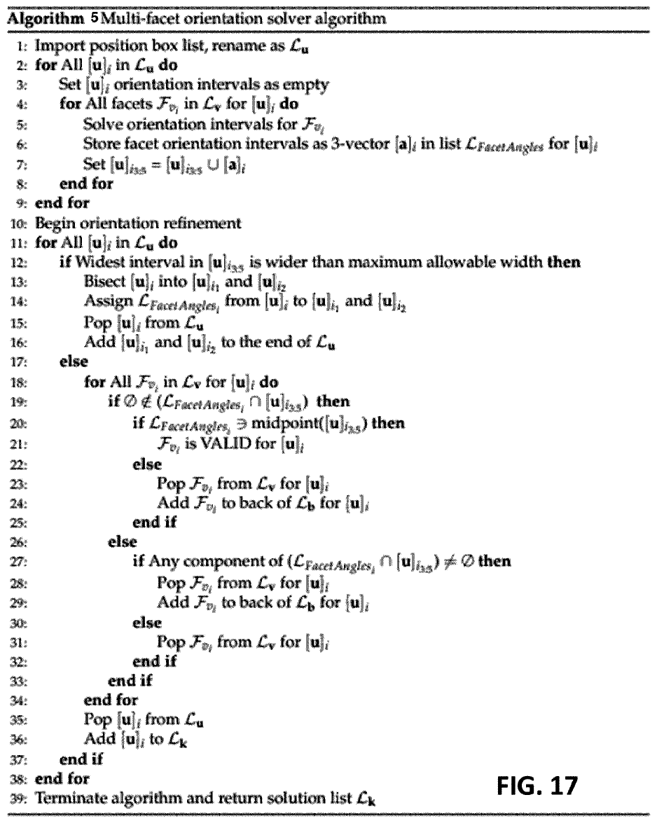

The third component, [β] defines the allowable roll of the camera about its axis after 416 rotations by [φ] and [γ]. To begin, we solve the interval projection of each facet vertex and 417 [p] onto the camera's image plane for any position in ([x], [y], [z])^{T} after rotations by [φ] and [γ]. As noted above in the third example embodiment, we call the corresponding interval vectors representing these projections [d]ₚᵢ, i=1, . . . , 3. Then, we define the constraints as indicated in equations (16) and (17) of FIG. 20B. We can subsequently use HC4 and ACID contractors to contract the domain of [β] to a point where the constraints are satisfied. An example of a process performed by orientation solver 1510 is summarized in Algorithm 5 of FIG. 17.

### Lens Distortion Solver 1512

Once the full set of 6D boxes has been synthesized, a final check must be performed before they can be considered to be the full solution set bound by real camera constraints. This final step is checking that all facets which are considered valid for any given box will still be present in a captured image from any pose within the set of valid poses even if the captured image is subject to lens distortion. Lens distortion is the warping of images due to the elliptical geometry of lenses and results in image points being shifted on the image plane away from the points at which they would be expected to project in an ideal pinhole projection. This presents typically as straight lines presenting as curved lines in images.

The basic principles underlying how world coordinates are transformed into the camera's coordinate system and subsequently projected into an image using a pinhole camera model can be summarized as follows. An interval position in the world coordinate system, o_{W}=(x_{W}, y_{W}, z_{W})^{T}, is transformed into an interval projection in the camera's relative coordinate system, o_{C}=(x_{C}, y_{C}, z_{C})^{T} according to Equation (18) as shown in FIG. 20C, in which [RIT] is the camera's homogeneous transformation matrix. However, at this point, the realistic projection model diverges. First, the x and y components of the image plane projected points are transformed according to Equations (19) and (20) as shown in FIG. 20C. The quantities r²_{img} and γ are then be derived, according to Equations (21) and (22) as shown in FIG. 20C.

In Equation 22, the constants Kᵢ are the lens radial distortion constants from the standard Brown-Conrady distortion model. The projected x′_{img} and y′_{img} components are then further transformed according to Equations (23) and (24) as shown in FIG. 20C, in which constants Pᵢ are the Brown-Conrady tangential distortion coefficients. Both Pᵢ and Kᵢ can be derived according to standard and well-defined camera calibration algorithms for machine vision. The projection of the point o_{C} onto the image plane is then defined as shown in Equation (25) of FIG. 20C.

In Equation (25), cₓ and c_{y} are the camera image center coordinates, mₓ and m_{y} are the pixel dimensions of the sensor, and ƒₓ and ƒ_{y} are the camera x- and y-axis focal lengths. While mₓ and m_{y} are manufacturer-defined parameters, cₓ, c_{y}, ƒₓ and ƒ_{y} are derived according to standard camera calibration algorithms.

In order to test that a given valid facet for a given box is fully contained in a captured image from any pose within the set, the bounding boxes containing the full set of possible projected positions of the facet's vertices are derived using Equations (18)-(20). Their projections onto the image plane accounting for distortion are then solved by contracting over a system bound by equality constraints defined by Equation (25). This defines the box which is certified to most tightly bound the box containing the projection of the facet onto the image plane in the presence of lens distortions. Then, the image plane projection of this bounding box is compared to the area covered by the sensor on the image plane, and if it falls entirely within the area covered by the sensor, it is kept as a valid facet. If it only partially intersects the sensor, it is pushed to the boundary facet list, and if the intersection is empty then the facet is eliminated altogether from the box's valid/boundary facet lists.

### Deployment Recommendation

Once the full set of valid poses has been synthesized via the deployment solver, a deployment recommendation process suggests the best possible deployments for a given camera. The size of the final pose trees, as they often contain thousands of boxes which in turn renders human selection of pose boxes impractical.

There are two primary algorithms developed for deployment selection: the single-camera deployment case and the multi-camera deployment case.

### Single Camera Deployment Recommendation

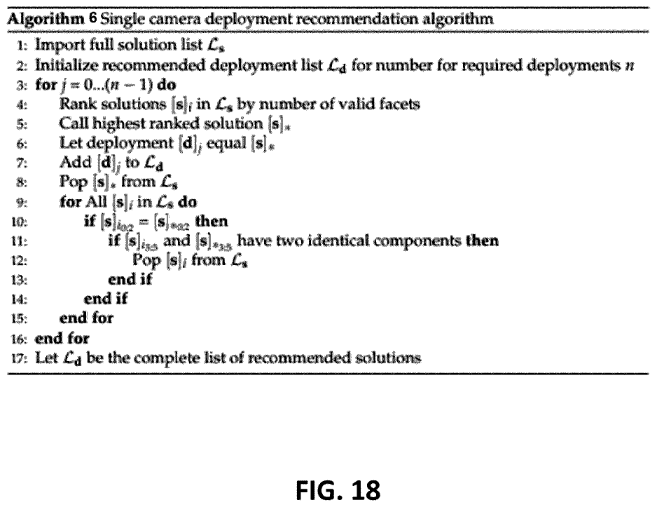

The single-camera deployment recommendation algorithm is an adapted greedy optimization algorithm in which the objective is simply the selection of boxes with the largest number of valid facets. To initialize the algorithm, the user first loads in the full set of pose intervals along with the facets of interest and then specifies how many recommendations are required. Once those parameters are initialized, the algorithm scans the set of poses and selects that with the largest number of associated valid facets as the first recommended deployment set. This pose interval is then eliminated from consideration for future recommendations. It then finds all other pose intervals which share five of six components as the currently recommended interval and eliminates them from consideration as well. This step is performed because during orientation bisection, due to the orientation interval width requirements, orientation intervals are often bisected in a way that results in there being multiple boxes with identical [x]-[y]-[z] position vectors and two identical orientation intervals. This often presents functionally redundant solutions as these intervals often share identical valid facet lists. As such, they are removed to avoid redundancies in recommendations. This process then repeats with the remaining available poses until the required number of recommended deployments has been identified. The algorithm is summarized in Algorithm 6 of FIG. 18.

### Multiple Camera Deployment Recommendation

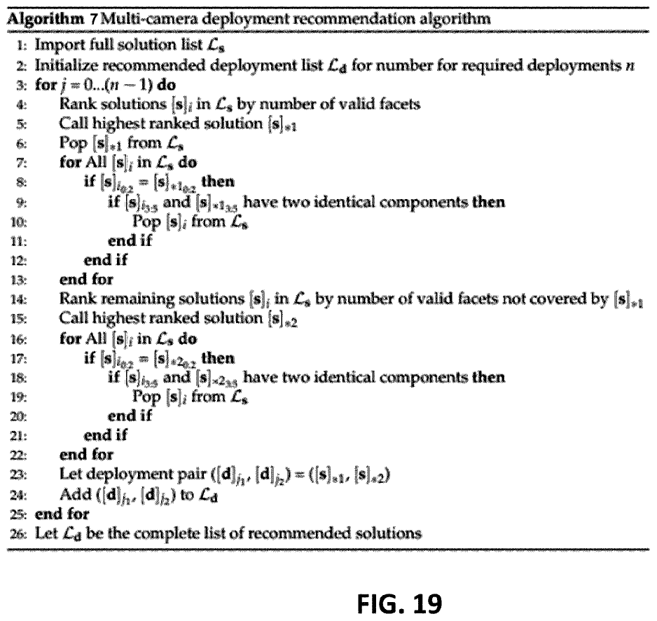

The case of the multiple-camera recommendation algorithm is slightly more complex than the single-camera recommendation algorithm, but it is still essentially a modified greedy optimization at its core. The algorithm will be explained for a two-camera deployment case, however, the concepts are the same for any number of required cameras. First, the algorithm scans the complete set of solutions and finds the boxes therein with the highest number of valid facets. Next, it scans the solution set for a second box which contains the most valid facets not covered by the first choice. Since this example case only covers a two-camera deployment, this particular recommendation would then be considered complete. However, were more cameras required, the process would continue finding subsequent maximum-remaining-coverage boxes until the required number had been selected. When the algorithm then proceeds to subsequent deployment selections, it functions practically identically, except for a small extra first step in which the boxes already selected in previous recommendations are removed from consideration for future ones (along with any redundant boxes, as in the single-camera case). This is done to encourage diversity in recommended deployment solutions. The algorithm is summarized in Algorithm 7 shown in FIG. 19.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

### LIST OF REFERENCE DOCUMENTS

The contents of all published documents identified in this disclosure, including the following, are hereby incorporated in their entirety by reference.
[1]J. Kritter, M. Brevilliers, J. Lepagnot, and L. Idoumghar, “On the optimal placement of cameras for surveillance and the underlying set cover problem,” Appl. Soft Comput., vol. 74, pp. 133-153, January 2019, doi: 10.1016/j.asoc.2018.10.025.
[2]S. Sakane, M. Ish, and M. Kakikura, “Occlusion avoidance of visual sensors based on a hand-eye action simulator system: HEAVEN,” Adv. Robot., vol. 2, no. 2, pp. 149-165, 1987.
[3]S. A. Shafer, “Automation and Calibration for Robot Vision Systems,” Carnegie Mellon University, May 1988.
[4]E. Trucco, M. Umasuthan, A. M. Wallace, and V. Roberto, “Model-Based Planning of Optimal Sensor Placements for Inspection,” IEEE Trans. Robot. Autom., vol. 13, no. 2, pp. 182-194, 1997.
[5]K. A. Tarabanis, P. K. Allen, and R. Y. Tsai, “A Survey of Sensor Planning in Computer Vision,” IEEE Trans. Robot. Autom., vol. 11, no. 1, pp. 86-104, February 1995.
[6]S. Sakane, R. Niepold, T. Sato, and Y. Shirai, “Illumination setup planning for a hand-eye system based on an environmental model,” Adv. Robot., vol. 6, no. 4, pp. 461-482, 1991.
[7]S. Fleishman, D. Cohen-Or, and D. Lischinski, “Automatic Camera Placement for Image-Based Modeling,” 1999.
[8]R. Arsinte, “STUDY OF A ROBUST ALGORITHM APPLIED IN THE OPTIMAL POSITION TUNING FOR THE CAMERA LENS IN AUTOMATED VISUAL INSPECTION SYSTEMS,” 1999.
[9]B. A. Barsky, D. R. Horn, S. A. Klein, J. A. Pang, and M. Yu, “Camera Models and Optical Systems Used in Computer Graphics: Part I, Object-Based Techniques,” University of California, Berkeley.
[10]X. Zhang, J. L. Alarcon-Herrera, and X. Chen, “Optimization for 3D Model-based Multi-Camera Deployment,” 2014.
[11]X. Zhang, X. Chen, J. L. Alarcon-Herrera, and Y. Fang, “3-D Model-Based Multi-Camera Deployment: A Recursive Convex Optimization Approach,” IEEEASME Trans. Mechatron., 2015.
[12]Z. Lu and L. Cai, “Camera calibration method with focus-related intrinsic parameters based on the thin-lens model,” Opt. Express, vol. 28, no. 14, pp. 20858-20878, 2020.
[13]F. Angella, L. Reithler, and F. Gallesio, “Optimal deployment of cameras for video surveillance systems,” in 2007 IEEE Conference on Advanced Video and Signal Based Surveillance, September 2007, pp. 388-392, doi: 10.1109/AVSS.2007.4425342.
[14]R. Yaagoubi, M. E. Yarmani, A. Kamel, and W. Khemiri, “HybVOR: A Voronoi-Based 3D GIS Approach for Camera Surveillance Network Placement,” ISPRS Int. J. Geo-Inf., vol. 4, no. 2, Art. no. 2, June 2015, doi: 10.3390/ijgi4020754.
[15]P. David, V. Idasiak, and F. Kratz, “A Sensor Placement Approach for the Monitoring of Indoor Scenes,” in Smart Sensing and Context, Berlin, Heidelberg, 2007, pp. 110-125, doi: 10.1007/978-3-540-75696-5_7.
[16]N. Conci and L. Lizzi, “Camera placement using particle swarm optimization in visual surveillance applications,” in 2009 16th IEEE International Conference on Image Processing (ICIP), November 2009, pp. 3485-3488, doi: 10.1109/ICIP.2009.5413833.
[17]Y. Morsly, N. Aouf, M. S. Djouadi, and M. Richardson, “Particle Swarm Optimization Inspired Probability Algorithm for Optimal Camera Network Placement,” IEEE Sens. J., vol. 12, no. 5, pp. 1402-1412, May 2012, doi: 10.1109/JSEN.2011.2170833.
[18]F. Janoos, R. Machiraju, R. Parent, J. W. Davis, and A. Murray, “Sensor configuration for coverage optimization in surveillance applications,” in Videometrics IX, January 2007, vol. 6491, p. 649105, doi: 10.1117/12.704062.
[19]B. Zhang, X. Zhang, X. Chen, and Y. Fang, “A differential evolution approach for coverage optimization of visual sensor networks with parallel occlusion detection,” in 2016 IEEE International Conference on Advanced Intelligent Mechatronics (AIM), July 2016, pp. 1246-1251, doi: 10.1109/AIM.2016.7576941.
[20] Kenichi Yabuta and Hitoshi Kitazawa, “Optimum camera placement considering camera specification for security monitoring,” in 2008 IEEE International Symposium on Circuits and Systems, May 2008, pp. 2114-2117, doi: 10.1109/ISCAS.2008.4541867.
[21]E. Horster and R. Lienhart, “Approximating Optimal Visual Sensor Placement,” in 2006 IEEE International Conference on Multimedia and Expo, July 2006, pp. 1257-1260, doi: 10.1109/ICME.2006.262766.
[22]U. M. Erdem and S. Sclaroff, “Automated camera layout to satisfy task-specific and floor plan-specific coverage requirements,” Comput. Vis. Image Underst., vol. 103, no. 3, pp. 156-169, September 2006, doi: 10.1016/j.cviu.2006.06.005.
[23]R. M. Karp, “Reducibility among Combinatorial Problems,” in Complexity of Computer Computations: Proceedings of a symposium on the Complexity of Computer Computations, held Mar. 20-22, 1972, at the IBM Thomas J. Watson Research Center, Yorktown Heights, New York, and sponsored by the Office of Naval Research, Mathematics Program, IBM World Trade Corporation, and the IBM Research Mathematical Sciences Department, R. E. Miller, J. W. Thatcher, and J. D. Bohlinger, Eds. Boston, MA: Springer US, 1972, pp. 85-103.
[24]Y. Wang, D. Ouyang, L. Zhang, and M. Yin, “A novel local search for unicost set covering problem using hyperedge configuration checking and weight diversity,” Sci. China Inf. Sci., vol. 60, no. 6, p. 062103, February 2017, doi: 10.1007/s11432-015-5377-8.
[25]E. Balas and A. Ho, “Set covering algorithms using cutting planes, heuristics, and subgradient optimization: A computational study,” in Combinatorial Optimization, M. W. Padberg, Ed. Berlin, Heidelberg: Springer, 1980, pp. 37-60.
[26]D. P. Chandu, “Big Step Greedy Algorithm for Maximum Coverage Problem,” ArXiv150606163 Cs, September 2015, Accessed: Jan. 18, 2021. [Online]. Available: http://arxiv.org/abs/1506.06163.
[27]A. V. Eremeev, “A Genetic Algorithm with a Non-Binary Representation for the Set Covering Problem,” in Operations Research Proceedings 1998, Berlin, Heidelberg, 1999, pp. 175-181, doi: 10.1007/978-3-642-58409-1_17.
[28]L. Lessing, I. Dumitrescu, and T. Stützle, “A Comparison Between ACO Algorithms for the Set Covering Problem,” in Ant Colony Optimization and Swarm Intelligence, Berlin, Heidelberg, 2004, pp. 1-12, doi: 10.1007/978-3-540-28646-2_1.
[29]S. Balaji and N. Revathi, “A new approach for solving set covering problem using jumping particle swarm optimization method,” Nat. Comput., vol. 15, no. 3, pp. 503-517, September 2016, doi: 10.1007/s11047-015-9509-2.
[30]S. AI-Shihabi, M. Arafeh, and M. Barghash, “An improved hybrid algorithm for the set covering problem,” Comput. Ind. Eng., vol. 85, pp. 328-334, July 2015, doi: 10.1016/j.cie.2015.04.007.
[31]S. Sundar and A. Singh, “A hybrid heuristic for the set covering problem,” Oper. Res., vol. 12, no. 3, pp. 345-365, November 2012, doi: 10.1007/s12351-010-0086-y.
[32]J. J. Q. Yu, A. Y. S. Lam, and V. O. K. Li, “Chemical reaction optimization for the set covering problem,” in 2014 IEEE Congress on Evolutionary Computation (CEC), July 2014, pp. 512-519, doi: 10.1109/CEC.2014.6900233.
[33] Moore, R. E.; Kearfott, R. B.; Cloud, M. J. Introduction to Interval Analysis; Society for Industrial and Applied Mathematics: Philadelphia, PA, USA, 2009.
[34] Benhamou, F.; Goualard, F.; Granvilliers, L. Revising hull and box consistency. In Proceedings of the 16th International Conference on Logic Programming, Las Cruces, NM, USA, 29 November-4 Dec. 1999; The MIT Press: Cambridge, MA, USA, 1999; pp. 230-244.

1. A computer implemented method for computing a camera deployment solution for an inspection task within an environment, comprising:
obtaining a set of data that includes: (i) a 3D-mesh model of a part to be inspected, the 3D-mesh model defining surfaces of the part as a mesh of facets; (ii) a first camera description that specifies multiple imaging properties of a first camera; and (iii) environment data indicating one or more physical characteristics of the environment;
defining, based on the set of data, an initial camera pose space for a first facet of the mesh of facets, the initial camera pose space comprising a set of initial camera pose intervals, each initial camera pose interval being defined by a set of minimum and maximum pose boundaries within the environment;
performing an iterative loop, based on the initial camera pose space and the first camera description to compute a final camera pose space comprising a set of one or more final camera pose intervals, wherein each of the final camera pose intervals specifies a respective set of minimum and maximum pose boundaries for the first camera within the environment that enable the first camera to capture an image of the first facet that satisfies a set of defined inspection task constraints; and
selecting one or more of the final camera pose intervals of the final camera pose space for inclusion in the camera deployment solution.

2. The method of claim 1 wherein the set of minimum and maximum pose boundaries that define the initial camera pose intervals and the set of minimum and maximum pose boundaries that define the final camera pose intervals each include a set of 3D positional boundaries and set of 3D orientation boundaries.

3. The method of claim 1 wherein the set of defined inspection task constraints require that the first facet must be visible in the image and in compliance with defined focus and resolution criteria.

4. The method of claim 1 wherein performing the iterative loop comprises hierarchically sub-dividing at least some of the initial camera pose intervals into child camera pose intervals to acquire the final camera pose intervals.

5. The method of claim 1 wherein performing the iterative loop comprises, for each of the initial camera pose intervals:
determining if all possible camera poses within the initial camera pose interval enable the first camera to capture an image of the first facet that satisfies the set of defined inspection task constraints, and if so accepting the initial camera pose interval as one of the final camera pose intervals for inclusion in the final camera pose space;
determining if none of the possible camera poses within the initial camera pose interval enable the first camera to capture an image of the first facet that satisfies the set of defined inspection task constraints, and if so rejecting the initial camera pose interval as a final camera pose interval; and
determining is some, but not all, of the possible camera poses within the initial camera pose interval enable the first camera to capture an image of the first facet that satisfies the set of defined inspection task requirements, and if so, hierarchically sub-dividing the initial camera pose interval into child camera pose intervals to acquire a first set of one or more child camera pose intervals that enable the first camera to capture an image of the first facet that satisfies the set of defined inspection task constraints, and including the one or more child camera pose intervals of the first set as respective final camera pose intervals for inclusion in the final camera pose space.

6. The method of claim 4 wherein the one or more final camera pose intervals includes final pose intervals that have been computed to specify a respective set of minimum and maximum pose boundaries for the first camera within the environment that enable the first camera to capture an image of a group of facets of the mesh of facets including the first facet and satisfy the set of defined inspection task constraints for all of the facets in the group of facets.

7. The method of claim 6 wherein:
each final camera pose interval is described by a respective pose interval descriptor that indicates: the respective set of minimum and maximum pose boundaries and a list of all facets in the group of facets; and
each initial camera pose interval is described by a respective pose interval descriptor, and
wherein performing the iterative loop comprises derivinq respective pose interval descriptors for each of the child camera pose intervals that indicates: the respective set of minimum and maximum pose boundaries; a list of selected facets from the mesh of facets; and for each facet in the list of selected facets an indication as to whether the set of defined inspection task constraints is satisfied for the facet.

8. (canceled)

9. The method of claim 8 wherein obtaining the set of data includes obtaining the list of selected facets from the mesh of facets and obtaining a list of external facets, wherein the list of selected facets correspond to facets that are required to be inspected as part of the camera deployment solution and the list of external facets correspond to facets that are not required to be inspected.

10. The method of claim 9 wherein obtaining the list of selected facets and the list of external facets comprises presenting a representation of the 3D-mesh model in a graphical user interface and detecting user inputs interacting with the representation and indicating the selected facets and external facets.

11. The method of claim 1 wherein the set of data includes a plurality of camera descriptions for a plurality of different cameras including the first camera, wherein respective initial camera pose spaces and final camera pose spaces are determined for each of the plurality of different cameras.

12. The method of claim 11 comprising obtaining the plurality of camera descriptions based on user inputs selecting cameras identified in a database of camera descriptors.

13. The method of claim 1 wherein selecting one or more of the final camera pose intervals of the final camera pose space for inclusion in the camera deployment solution comprises performing intersection analysis of the final camera pose intervals to identify a set of final camera pose intervals that requires a smallest number of cameras to implement.

14. The method of claim 1 comprising generating a graphical user interface that enables a user to selectively edit one or more of elements of the set of data, the method including re-performing the defining and performing based on the edits.

15. The method of claim 1 wherein the initial camera pose space corresponds to an existing set of camera deployment locations.

16. The method of claim 1 wherein the first camera description specifies imaging properties of the first camera including of at least two or more of: camera lens focal length; ratio of the camera lens focal length to a camera lens aperture diameter; a camera lens blur circle value; and a camera sensor size and pitch.

17. The method of claim 1 wherein the one or more physical characteristics of the environment indicated in the environment data includes camera location data indicating one or more locations for locating the first camera in the environment.

18. The method of claim 1 wherein the one or more physical characteristics of the environment indicated in the environment data include indications of one or more locations within the environment that interfere with a positioning of or a line of sight of the first camera.

19. The method of claim 1 wherein the set of defined inspection task constraints require that, for each final pose interval:
the final pose interval intersects the first facet;
the final pose interval is within a defined distance of the first facet;
the final pose interval is in front of the facet;
the final pose interval provides a viewing angle that enables the first facet to be inspected; and
the first facet is not occluded relative to the final pose interval.

20. (canceled)

21. (canceled)

22. A system, comprising:
one or more processing devices;
one or more non-transient memories coupled to the one or more processing devices, the one or more memories storing executable instructions, that when executed by the one or more processors configure the system to perform a method for computing a camera deployment solution for an inspection task, the method including:
obtaining a set of data that includes: (i) a 3D-mesh model of a part to be inspected, the 3D-mesh model defining surfaces of the part as a mesh of facets; (ii) a first camera description that specifies multiple imaging properties of a first camera; and (iii) environment data indicating one or more physical characteristics of an environment associated with the inspection task;
defining, based on the set of data, an initial camera pose space for a first facet of the mesh of facets, the initial camera pose space comprising a set of initial camera pose intervals, each initial camera pose interval being defined by a set of minimum and maximum pose boundaries within the environment;
performing an iterative loop, based on the initial camera pose space and the first camera description to compute a final camera pose space comprising a set of one or more final camera pose intervals, wherein each of the final camera pose intervals specifies a respective set of minimum and maximum pose boundaries for the first camera within the environment that enable the first camera to capture an image of the first facet that satisfies a set of defined inspection task constraints; and
selecting one or more of the final camera pose intervals of the final camera pose space for inclusion in the camera deployment solution.

23. The system of claim 22 of wherein the set of minimum and maximum pose boundaries that define the initial camera pose intervals and the set of minimum and maximum pose boundaries that define the final camera pose intervals each include a set of 3D positional boundaries and set of 3D orientation boundaries.
